(19) United States
(12) Patent Application Publication
(10) Pub. No.: US 2025/0085409 A1
(43) Pub. Date: Mar. 13, 2025

(54) LIDAR WINDOW BLOCKAGE AND NEARFIELD OBJECT DETECTION

(71) Applicant: Luminar Technologies, Inc., Orlando, FL (US)

(72) Inventors: Liviu I. Voicu, Casselberry, FL (US); Aseem D. Patil, Orlando, FL (US); Roman Krylov, Colorado Springs, CO (US); Lawrence H. Boxler, Winter Garden, FL (US)

(21) Appl. No.: 18/829,044

(22) Filed: Sep. 9, 2024

Related U.S. Application Data
(60) Provisional application No. 63/537,653, filed on Sep. 11, 2023.

(51) Int. Cl. G01S 7/497; G01S 7/481; G01S 17/89

(52) U.S. Cl. CPC G01S 7/497; G01S 7/4813; G01S 7/4817; G01S 17/89; G01S 2007/4977

(57) ABSTRACT

A scanner is configured to scan the emitted light through a window. A first detector is positioned to receive at least a portion of the emitted light scattered by a downrange target. A second detector is positioned to receive at least a portion of the emitted light scattered by a window obscurant. A third detector is positioned to receive at least a portion of the emitted light scattered by a close obscurant located within a distance range that is between a minimum detection distance associated with the first detector and a maximum detection distance associated with the second detector. A processor is configured to determine whether an obscurant located closer to the window than the minimum detection distance associated with the first detector is detected based on one or more signal properties of the second detector and one or more signal properties of the third detector.

### CROSS REFERENCE TO OTHER APPLICATIONS

This application claims priority to U.S. Provisional Patent Application No. 63/537,653 entitled LIDAR WINDOW BLOCKAGE AND NEARFIELD OBJECT DETECTION filed Sep. 11, 2023 which is incorporated herein by reference for all purposes.

### BACKGROUND OF THE INVENTION

Light detection and ranging (lidar) is a technology that can be used to measure distances to remote targets. Typically, a lidar system includes a light source and an optical receiver. The light source can include, for example, a laser which emits light having a particular operating wavelength. The operating wavelength of a lidar system may lie, for example, in the infrared, visible, or ultraviolet portions of the electromagnetic spectrum. The light source emits light toward a target which scatters the light, and some of the scattered light is received back at the receiver. The system determines the distance to the target based on one or more characteristics associated with the received light. For example, the lidar system may determine the distance to the target based on the time of flight for a pulse of light emitted by the light source to travel to the target and back to the lidar system.

### BRIEF DESCRIPTION OF THE DRAWINGS

Various embodiments of the invention are disclosed in the following detailed description and the accompanying drawings.

FIG. 1 illustrates an example light detection and ranging (lidar) system.

FIG. 2 illustrates an example scan pattern produced by a lidar system.

FIG. 3 illustrates an example lidar system with an example rotating polygon mirror.

FIG. 4 illustrates an example light-source field of view (FOVL) and receiver field of view (FOVR) for a lidar system.

FIG. 5 illustrates an example unidirectional scan pattern that includes multiple pixels and multiple scan lines.

FIG. 6 illustrates an example of an obscurant located on the window causing a portion of a laser beam to be reflected by the obscurant or absorbed by the obscurant material.

FIG. 7A illustrates an example of a hypothetical geometry showing the cumulated transmit aperture and the cumulated receive aperture of a main detector over the entire scan.

FIG. 7B illustrates a system with a single ray, in which the receive instantaneous field of view (IFOV) of the blockage detector is not completely overlapping with the transmit IFOV of the system.

FIG. 8 is a flow chart illustrating an embodiment of a process 800 of a lidar system for window blockage or nearfield object detection.

FIG. 9A shows an example of a possible distribution of detectors and return projections on the detector plane.

FIG. 9B illustrates an example lidar system 100 with an example obscurant 922 on a sensor window 920.

FIG. 10 illustrates an exemplary system 1000 for detecting different types of blockage.

FIG. 11 shows the various electronic signals produced by the detector circuitry.

FIG. 12 shows an example chart 1200 for calibrating an energy comparison criterion.

FIG. 13 illustrates the examples of inputs, settings, and flags for calibrating logic module 1010.

FIG. 14 illustrates an exemplary process 1400 that may be performed by logic module 1010.

FIG. 15 illustrates an example of a window blockage map and an example of a nearfield blockage map when obscurants are located on the window.

FIG. 16 illustrates an example of a window blockage map and an example of a nearfield blockage map when obscurants are located on an obscurant screen placed in front of the window.

FIG. 17 shows comparatively the impact that photons blocked at transmission (the left cluster) and reception (the right cluster) have on imaging a wall that is 5 meters away from the sensor.

FIG. 18 illustrates a blockage energy map of large droplets of water applied to one small area of the window.

FIG. 19 illustrates a detection mask with synthetic circular obscurants on the window.

FIG. 20 illustrates a detection mask calculated for a human hand.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Window blockage or nearfield object detection for light detection and ranging (lidar) systems is disclosed. Using the disclosed systems and techniques, a blocking contaminant on the sensor window of a lidar system or a nearfield object in front of the sensor window can be detected. In various embodiments, a blocking contaminant on the sensor window can interfere with the accuracy of the lidar system. For example, a blocking contaminant can make it difficult for the lidar system to accurately detect and/or determine the distance of downrange targets. Instead of reaching the downrange target, at least a portion of the output beam emitted from the lidar system is instead scattered and/or absorbed by the blocking contaminant.

In various embodiments, the blocking contaminants associated with a sensor window can be heavily influenced by the usage scenario of the lidar system. For example, in automotive applications, the contaminant can be a foreign object such as dust, liquids, or other environmental contaminants, such as road debris. In some embodiments, the blocking contaminant is due to degradation of the sensor window, such as degradation caused by a chip, pitting, and/or ultraviolet (UV) light damage to the sensor window. In various embodiments, the disclosed invention detects a variety of different blocking contaminants associated with the sensor window by detecting the light scattered by the blocking contaminant using one or more additional detectors. For example, in addition to a first detector for detecting downrange objects, a second detector is placed in the receiver of the lidar system to detect at least a portion of the emitted light that is scattered by the blocking contaminant on the sensor window. The position of a blocking contaminant detector is located such that the blocking contaminant detector accurately detects light scatter from an object on or very near to the sensor window. A third detector is placed in the receiver of the lidar system to detect at least a portion of the emitted light that is scattered by a close obscurant located within a distance range including a distance span between a minimum detection distance associated with the first detector and a maximum detection distance associated with the second detector.

In various embodiments, at least some of the detectors of the receiver are positioned to detect objects downrange. For the disclosed systems, the captured scatter pattern for downrange objects and blocking contaminants is different and each scatter pattern utilizes a different set of detectors. The downrange object detectors are positioned to optimally detect downrange objects. The blocking contaminant detectors are positioned to identify blocking contaminants on the sensor window that could impact the downrange object detectors and the overall accuracy of the lidar system. The nearfield object detectors are positioned to identify nearfield objects in front of the sensor window.

In some embodiments, the output of the lidar system is used to trigger a response to address an identified blocking contaminant or a nearfield object. For example, in the event a blocking contaminant is detected on the sensor window, a cleaning process, a sensor window replacement process, and/or an additional inspection process can be initiated. For example, a cleaning process can clear debris such as dust or mud from the sensor window. As another example, a replacement process can be utilized to replace or repair a sensor window that is pitted or chipped. In some embodiments, the output of the lidar system is a notification that the sensor window contains a blockage. In some embodiments, the output of the lidar system is a light reading from one or more of the blocking contaminant detectors. For example, the captured sensor data from each blocking contaminant detector can be used to determine intensity readings. For example, in the event a nearfield object in front of the window is detected, the output power may be reduced for safety reasons in case the close object is a human head. A lower output power is warranted to avoid potential damage to eyes and/or other human tissues.

In some embodiments, a lidar system comprises at least a light source, a scanner, a first detector, a second detector, a third detector, and a processor. The light source is configured to emit light and the scanner is configured to scan the emitted light across a field of regard through a window. For example, a light source such as a laser can emit light of a particular operating wavelength that is scanned by the scanner towards a particular scan region or field of regard. The field of regard may be, for example, the area in front of a vehicle. Other fields of regard are appropriate as well, such as along the sides or behind the vehicle. The emitted light passes through a sensor window before reaching any downrange objects. In some embodiments, the sensor window is used at least in part to protect the lidar system, for example, from environmental elements such as road debris and weather. In various embodiments, the lidar system includes multiple detectors, for example, as part of a receiver module. The detectors can utilize different types of technology to detect scattered light. For example, one or more of the detectors can utilize avalanche photodiodes (APDs), one or more single-photon avalanche diodes (SPADs), one or more PN photodiodes, or one or more PIN photodiodes, etc. The first detector of the lidar system is configured to detect at least a portion of the emitted light scattered by a target located downrange from the system. For example, the positioning of the first detector is optimized to detect objects that are a certain distance from the lidar system and/or the application environment to which the lidar system is mounted, such as an automobile. In some embodiments, the first detector is optimized to detect objects that are up to 50 meters, 200 meters, or another distance away from the lidar system. The second detector of the lidar system is configured to detect at least a portion of the emitted light scattered by a blocking contaminant on the window. For example, contaminants on or embedded in the sensor window are detected by the second detector. The third detector of the lidar system is configured to detect at least a portion of the emitted light by a close obscurant located within a distance range including a distance span between a minimum detection distance associated with the first detector and a maximum detection distance associated with the second detector. In various embodiments, the first, second, and third detectors are different detectors and are configured to detect different scatter patterns. The processor of the lidar system is configured to compare one or more signal properties of the second detector and one or more signal properties of the third detector to detect a presence of an obscurant located closer to the window than the minimum detection distance associated with the first detector.

A lidar system operates in a vehicle and includes multiple “eyes,” each of which has its own field of regard, or an angular range over which the eye scans targets using pulses of light in accordance with a scan pattern. The fields of regard can combine along a certain dimension (e.g., horizontally) to define the overall field of regard of the lidar system. The lidar system then can use data received via both eyes to generate a point cloud or otherwise process the received data.

In a two-eye configuration of the lidar system, the two eyes can be housed together and scan the respective fields of regard via a shared window or separate windows, or the eyes can be housed separately. In the latter case, an assembly referred to as a “sensor head” can include a scanner, a receiver, and an optical element such as a collimator or a laser diode to generate or convey a beam of light.

Depending on the implementation, each eye of a lidar system can include a separate scanner (e.g., each eye can be equipped with a pivotable scan mirror to scan the field of regard vertically and another pivotable scan mirror to scan the field of regard horizontally), a partially shared scanner (e.g., each eye can be equipped with a pivotable scan mirror to scan the field of regard vertically, and a shared polygon mirror can scan the corresponding fields of regard horizontally, using different reflective surfaces), or a fully shared scanner (e.g., a pivotable planar mirror can scan the fields of regard vertically by reflecting incident beams at different regions on the reflective surface, and a shared polygon mirror can scan the corresponding fields of regard horizontally, using different reflective surfaces).

Different hardware configurations allow the lidar system to operate the eyes more independently of each other, as is the case with separate scanners, or less independently, as is the case with a fully shared scanner. For example, the two or more eyes may scan the respective fields of regard using similar or different scan patterns. In one implementation, the two eyes trace out the same pattern, but with a certain time differential to maintain angular separation between light-source fields of view and thereby reduce the probability of cross-talk events between the sensor heads. In another implementation, the two eyes scan the corresponding fields of regard according to different scan patterns, at least in some operational states (e.g., when the vehicle is turning right or left).

Further, according to one approach, two eyes of a lidar system are arranged so that the fields of regard of the eyes are adjacent and non-overlapping. For example, each field of regard can span approximately 60 degrees horizontally and 30 degrees vertically, so that the combined field of regard of the lidar system spans approximately 120 degrees horizontally and 30 degrees vertically. The corresponding scanners (or paths within a shared scanner) can point away from each other at a certain angle, for example, so that the respective fields of regard abut approximately at an axis corresponding to the forward-facing direction of the vehicle.

Alternatively, the lidar system can operate in a “cross-eyed” configuration to create an area of overlap between the fields of regard. The area of overlap can be approximately centered along the forward-facing direction or another direction, which in some implementations a controller can determine dynamically. In this implementation, the two sensor heads can yield a higher density of scan in the area that generally is more important. In some implementations, the fields of regard in a cross-eyed two-eye configuration are offset from each other by a half-pixel value, so that the area of overlap has twice as many pixels. In general, the fields of regard can overlap angularly or translationally. To reduce the probability of cross-talk events (e.g., the situation when a pulse emitted by the light source associated with the first eye is received by the receiver of the second eye), the lidar system can use output beams with different wavelengths.

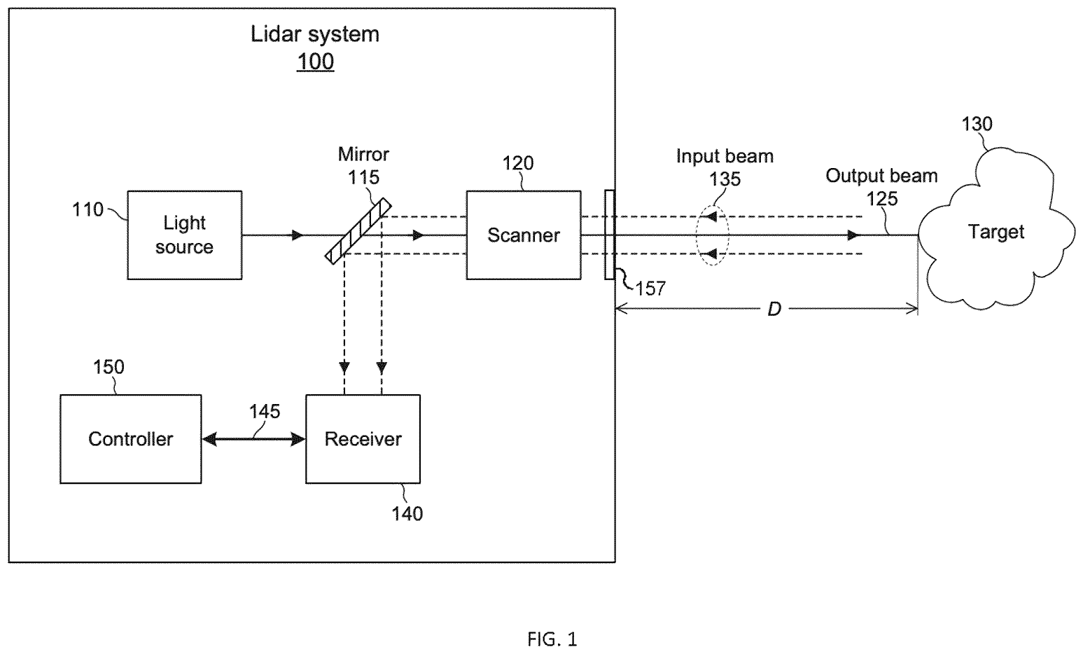

FIG. 1 illustrates an example light detection and ranging (lidar) system 100. In particular embodiments, a lidar system 100 may be referred to as a laser ranging system, a laser radar system, a LIDAR system, a lidar sensor, or a laser detection and ranging (LADAR or ladar) system. In particular embodiments, a lidar system 100 may include a light source 110, mirror 115, scanner 120, receiver 140, controller 150, or sensor window 157. The light source 110 may include, for example, a laser which emits light having a particular operating wavelength in the infrared, visible, or ultraviolet portions of the electromagnetic spectrum. As an example, light source 110 may include a laser with one or more operating wavelengths between approximately 900 nanometers (nm) and 2000 nm. The light source 110 emits an output beam of light 125 which may be continuous wave (CW), pulsed, or modulated in any suitable manner for a given application. The output beam of light 125 is directed downrange toward a remote target 130. As an example, the remote target 130 may be located a distance D of approximately 1 m to 1 km from the lidar system 100.

Once the output beam 125 reaches the downrange target 130, the target may scatter or reflect at least a portion of light from the output beam 125, and some of the scattered or reflected light may return toward the lidar system 100. In the example of FIG. 1, the scattered or reflected light is represented by input beam 135, which passes through sensor window 157 and scanner 120 and is then reflected by mirror 115 and directed to receiver 140. In particular embodiments, a relatively small fraction of the light from output beam 125 may return to the lidar system 100 as input beam 135. As an example, the ratio of input beam 135 average power, peak power, or pulse energy to output beam 125 average power, peak power, or pulse energy may be approximately 10⁻¹, 10⁻², 10⁻³, 10⁻⁴, 10⁻⁵, 10⁻⁶, 10⁻⁷, 10⁻⁸, 10⁻⁹, 10⁻¹⁰, 10⁻¹¹, or 10⁻¹². As another example, if a pulse of output beam 125 has a pulse energy of 1 microjoule (μJ), then the pulse energy of a corresponding pulse of input beam 135 may have a pulse energy of approximately 10 nanojoules (nJ), 1 nJ, 100 picojoules (pJ), 10 pJ, 1 pJ, 100 femtojoules (fJ), 10 fJ, 1 fJ, 100 attojoules (aJ), 10 aJ, 1 aJ, or 0.1 aJ.

In particular embodiments, output beam 125 may include or may be referred to as an optical signal, output optical signal, emitted optical signal, output light, emitted pulse of light, laser beam, light beam, optical beam, emitted beam, emitted light, or beam. In particular embodiments, input beam 135 may include or may be referred to as a received optical signal, received pulse of light, input pulse of light, input optical signal, return beam, received beam, return light, received light, input light, scattered light, or reflected light. As used herein, scattered light may refer to light that is scattered or reflected by a target 130. As an example, an input beam 135 may include: light from the output beam 125 that is scattered by target 130; light from the output beam 125 that is reflected by target 130; or a combination of scattered and reflected light from target 130.

In various embodiments, lidar system 100 includes sensor window 157 through which the beams 125 and 135 pass. In many scenarios, sensor window 157 is free of obstructions and beams 125 and 135 pass through sensor window 157 with minimal degradation. However, under real world conditions, sensor window 157 is exposed to working conditions that can impact the condition of sensor window 157. For example, debris, UV light, weather, road conditions, etc. can create blocking contaminants on sensor window 157 that impact the operation of lidar system 100. In some scenarios, one or more blocking contaminants (not shown) exist on the surface or within sensor window 157. For example, dust, a chip, a pit, liquids, or another occlusion or blockage can damage or degrade a surface of sensor window 157, such as the exterior surface of sensor window 157 from which output beam 125 is intended to pass out from to reach a downrange object such as target 130. The output beam of light 125 is directed downrange towards a remote target 130 but a blocking contaminant of sensor window 157 may scatter or reflect at least a portion of light from the output beam 125 before it reaches remote target 130. Some of the scattered or reflected light from the blockage may return toward the lidar system 100. The light scattered or reflected by the blocking contaminant takes a path similar to input beam 135 and passes through at least a portion of sensor window 157. The light then passes through scanner 120 and is reflected by mirror 115 and directed to receiver 140. In some embodiments, the light scattered or reflected by the blocking contaminant that returns toward the lidar system 100 is an embodiment of input beam 135. For example, although not shown to scale in FIG. 1, in some embodiments, target 130 is not a downrange object but a blocking contaminant on the surface of sensor window 157 and the distance D that target 130 is located from lidar system 100 is effectively zero. In this scenario, target 130 can be a blocking contaminant such as dirt embedded on the surface of sensor window 157 or another blocking contaminant impacting the interior of sensor window 157 such as a chip or pit. Although not shown to scale in FIG. 1, in some embodiments, target 130 is not a downrange object but a close object located between sensor window 157 and a minimum detection distance associated with using a type of detector of lidar system 100 associated with detecting downrange objects. For example, the close object may be a human head, and the minimum detection distance associated with using the type of detector of lidar system 100 associated with detecting downrange objects may be approximately 0.5 meters (e.g., greater than or equal to 0.5 meters). Thus, in some scenarios, a close object within 0.5 meters of sensor window 157 blocks downrange scanning using output beam 125. In particular embodiments, lidar system 100 is configured to lower the output power associated with output beam 125 when the close object is detected. The output power is lowered for various reasons, one being that the output power should be reduced for safety reasons in case the close object is a human head. Stated alternatively, a lower output power is warranted to avoid potential damage to eye and/or other human tissue. Furthermore, if there is a close object that is blocking downrange scanning, a higher output power is unnecessary because the lower output power is sufficient to detect close objects (e.g., within 0.5 meters of sensor window 157).

In particular embodiments, receiver 140 may receive or detect photons from input beam 135 and produce one or more representative signals. For example, the receiver 140 may produce an output electrical signal 145 that is representative of the input beam 135, and the electrical signal 145 may be sent to controller 150. In particular embodiments, receiver 140 or controller 150 may include a processor, computing system (e.g., an ASIC or FPGA), or other suitable circuitry. A controller 150 may be configured to analyze one or more characteristics of the electrical signal 145 from the receiver 140 to determine one or more characteristics of the target 130, such as its distance downrange from the lidar system 100. This may be done, for example, by analyzing a time of flight or a frequency or phase of a transmitted beam of light 125 or a received beam of light 135. If lidar system 100 measures a time of flight of T (e.g., T represents a round-trip time of flight for an emitted pulse of light to travel from the lidar system 100 to the target 130 and back to the lidar system 100), then the distance D from the target 130 to the lidar system 100 may be expressed as D=c·T/2, where c is the speed of light (approximately 3.0×10⁸ m/s). As an example, if a time of flight is measured to be T=300 ns, then the distance from the target 130 to the lidar system 100 may be determined to be approximately D=45.0 m. As another example, if a time of flight is measured to be T=1.33 μs, then the distance from the target 130 to the lidar system 100 may be determined to be approximately D=199.5 m. In particular embodiments, a distance D from lidar system 100 to a target 130 may be referred to as a distance, depth, or range of target 130. As used herein, the speed of light c refers to the speed of light in any suitable medium, such as for example in air, water, or vacuum. As an example, the speed of light in vacuum is approximately 2.9979×10⁸ m/s, and the speed of light in air (which has a refractive index of approximately 1.0003) is approximately 2.9970×10⁸ m/s.

In particular embodiments, light source 110 may include a pulsed or CW laser. As an example, light source 110 may be a pulsed laser configured to produce or emit pulses of light with a pulse duration or pulse width of approximately 10 picoseconds (ps) to 100 nanoseconds (ns). The pulses may have a pulse duration of approximately 100 ps, 200 ps, 400 ps, 1 ns, 2 ns, 5 ns, 10 ns, 20 ns, 50 ns, 100 ns, or any other suitable pulse duration. As another example, light source 110 may be a pulsed laser that produces pulses with a pulse duration of approximately 1-5 ns. As another example, light source 110 may be a pulsed laser that produces pulses at a pulse repetition frequency of approximately 100 kHz to 10 MHz or a pulse period (e.g., a time between consecutive pulses) of approximately 100 ns to 10 μs. In particular embodiments, light source 110 may have a substantially constant pulse repetition frequency, or light source 110 may have a variable or adjustable pulse repetition frequency. As an example, light source 110 may be a pulsed laser that produces pulses at a substantially constant pulse repetition frequency of approximately 640 kHz (e.g., 640,000 pulses per second), corresponding to a pulse period of approximately 1.56 μs. As another example, light source 110 may have a pulse repetition frequency (which may be referred to as a repetition rate) that can be varied from approximately 200 kHz to 3 MHz. As used herein, a pulse of light may be referred to as an optical pulse, a light pulse, or a pulse.

In particular embodiments, light source 110 may include a pulsed or CW laser that produces a free-space output beam 125 having any suitable average optical power. As an example, output beam 125 may have an average power of approximately 1 milliwatt (mW), 10 mW, 100 mW, 1 watt (W), 10 W, or any other suitable average power. In particular embodiments, output beam 125 may include optical pulses with any suitable pulse energy or peak optical power. As an example, output beam 125 may include pulses with a pulse energy of approximately 0.01 μJ, 0.1 μJ, 0.5 μJ, 1 μJ, 2 μJ, 10 μJ, 100 μJ, 1 mJ, or any other suitable pulse energy. As another example, output beam 125 may include pulses with a peak power of approximately 10 W, 100 W, 1 KW, 5 KW, 10 KW, or any other suitable peak power. The peak power (Pₚₑₐₖ) of a pulse of light can be related to the pulse energy (E) by the expression E=Pₚₑₐₖ·Δt, where Δt is the duration of the pulse, and the duration of a pulse may be defined as the full width at half maximum duration of the pulse. For example, an optical pulse with a duration of 1 ns and a pulse energy of 1 μJ has a peak power of approximately 1 kW. The average power (Pₐᵥ) of an output beam 125 can be related to the pulse repetition frequency (PRF) and pulse energy by the expression Pₐᵥ=PRF·E. For example, if the pulse repetition frequency is 500 kHz, then the average power of an output beam 125 with 1-μJ pulses is approximately 0.5 W.

In particular embodiments, light source 110 may include a laser diode, such as for example, a Fabry-Perot laser diode, a quantum well laser, a distributed Bragg reflector (DBR) laser, a distributed feedback (DFB) laser, a vertical-cavity surface-emitting laser (VCSEL), a quantum dot laser diode, a grating-coupled surface-emitting laser (GCSEL), a slab-coupled optical waveguide laser (SCOWL), a single-transverse-mode laser diode, a multi-mode broad area laser diode, a laser-diode bar, a laser-diode stack, or a tapered-stripe laser diode. As an example, light source 110 may include an aluminum-gallium-arsenide (AlGaAs) laser diode, an indium-gallium-arsenide (InGaAs) laser diode, an indium-gallium-arsenide-phosphide (InGaAsP) laser diode, or a laser diode that includes any suitable combination of aluminum (Al), indium (In), gallium (Ga), arsenic (As), phosphorous (P), or any other suitable material. In particular embodiments, light source 110 may include a pulsed or CW laser diode with a peak emission wavelength between 1200 nm and 1600 nm. As an example, light source 110 may include a current-modulated InGaAsP DFB laser diode that produces optical pulses at a wavelength of approximately 1550 nm. As another example, light source 110 may include a laser diode that emits light at a wavelength between 1500 nm and 1510 nm.

In particular embodiments, light source 110 may include a pulsed or CW laser diode followed by one or more optical-amplification stages. For example, a seed laser diode may produce a seed optical signal, and an optical amplifier may amplify the seed optical signal to produce an amplified optical signal that is emitted by the light source 110. In particular embodiments, an optical amplifier may include a fiber-optic amplifier or a semiconductor optical amplifier (SOA). For example, a pulsed laser diode may produce relatively low-power optical seed pulses which are amplified by a fiber-optic amplifier. As another example, a light source 110 may include a fiber-laser module that includes a current-modulated laser diode with an operating wavelength of approximately 1550 nm followed by a single-stage or a multi-stage erbium-doped fiber amplifier (EDFA) or erbium-ytterbium-doped fiber amplifier (EYDFA) that amplifies the seed pulses from the laser diode. As another example, light source 110 may include a continuous-wave (CW) or quasi-CW laser diode followed by an external optical modulator (e.g., an electro-optic amplitude modulator). The optical modulator may modulate the CW light from the laser diode to produce optical pulses which are sent to a fiber-optic amplifier or SOA. As another example, light source 110 may include a pulsed or CW seed laser diode followed by a semiconductor optical amplifier (SOA). The SOA may include an active optical waveguide configured to receive light from the seed laser diode and amplify the light as it propagates through the waveguide. The optical gain of the SOA may be provided by pulsed or direct-current (DC) electrical current supplied to the SOA. The SOA may be integrated on the same chip as the seed laser diode, or the SOA may be a separate device with an anti-reflection coating on its input facet or output facet. As another example, light source 110 may include a seed laser diode followed by an SOA, which in turn is followed by a fiber-optic amplifier. For example, the seed laser diode may produce relatively low-power seed pulses which are amplified by the SOA, and the fiber-optic amplifier may further amplify the optical pulses.

In particular embodiments, light source 110 may include a direct-emitter laser diode. A direct-emitter laser diode (which may be referred to as a direct emitter) may include a laser diode which produces light that is not subsequently amplified by an optical amplifier. A light source 110 that includes a direct-emitter laser diode may not include an optical amplifier, and the output light produced by a direct emitter may not be amplified after it is emitted by the laser diode. The light produced by a direct-emitter laser diode (e.g., optical pulses, CW light, or frequency-modulated light) may be emitted directly as a free-space output beam 125 without being amplified. A direct-emitter laser diode may be driven by an electrical power source that supplies current pulses to the laser diode, and each current pulse may result in the emission of an output optical pulse.

In particular embodiments, light source 110 may include a diode-pumped solid-state (DPSS) laser. A DPSS laser (which may be referred to as a solid-state laser) may refer to a laser that includes a solid-state, glass, ceramic, or crystal-based gain medium that is pumped by one or more pump laser diodes. The gain medium may include a host material that is doped with rare-earth ions (e.g., neodymium, erbium, ytterbium, or prascodymium). For example, a gain medium may include a yttrium aluminum garnet (YAG) crystal that is doped with neodymium (Nd) ions, and the gain medium may be referred to as a Nd:YAG crystal. A DPSS laser with a Nd:YAG gain medium may produce light at a wavelength between approximately 1300 nm and approximately 1400 nm, and the Nd:YAG gain medium may be pumped by one or more pump laser diodes with an operating wavelength between approximately 730 nm and approximately 900 nm. A DPSS laser may be a passively Q-switched laser that includes a saturable absorber (e.g., a vanadium-doped crystal that acts as a saturable absorber). Alternatively, a DPSS laser may be an actively Q-switched laser that includes an active Q-switch (e.g., an acousto-optic modulator or an electro-optic modulator). A passively or actively Q-switched DPSS laser may produce output optical pulses that form an output beam 125 of a lidar system 100.

In particular embodiments, an output beam of light 125 emitted by light source 110 may be a collimated optical beam having any suitable beam divergence, such as for example, a full-angle beam divergence of approximately 0.5 to 10 milliradians (mrad). A divergence of output beam 125 may refer to an angular measure of an increase in beam size (e.g., a beam radius or beam diameter) as output beam 125 travels away from light source 110 or lidar system 100. In particular embodiments, output beam 125 may have a substantially circular cross section with a beam divergence characterized by a single divergence value. As an example, an output beam 125 with a circular cross section and a full-angle beam divergence of 2 mrad may have a beam diameter or spot size of approximately 20 cm at a distance of 100 m from lidar system 100. In particular embodiments, output beam 125 may have a substantially elliptical cross section characterized by two divergence values. As an example, output beam 125 may have a fast axis and a slow axis, where the fast-axis divergence is greater than the slow-axis divergence. As another example, output beam 125 may be an elliptical beam with a fast-axis divergence of 4 mrad and a slow-axis divergence of 2 mrad.

In particular embodiments, an output beam of light 125 emitted by light source 110 may be unpolarized or randomly polarized, may have no specific or fixed polarization (e.g., the polarization may vary with time), or may have a particular polarization (e.g., output beam 125 may be linearly polarized, elliptically polarized, or circularly polarized). As an example, light source 110 may produce light with no specific polarization or may produce light that is linearly polarized.

In particular embodiments, lidar system 100 may include one or more optical components configured to reflect, focus, filter, shape, modify, steer, or direct light within the lidar system 100 or light produced or received by the lidar system 100 (e.g., output beam 125 or input beam 135). As an example, lidar system 100 may include one or more lenses, mirrors, filters (e.g., band-pass or interference filters), beam splitters, optical splitters, polarizers, polarizing beam splitters, wave plates (e.g., half-wave or quarter-wave plates), diffractive elements, holographic elements, isolators, couplers, detectors, beam combiners, or collimators. The optical components in a lidar system 100 may be free-space optical components, fiber-coupled optical components, or a combination of free-space and fiber-coupled optical components.

In particular embodiments, lidar system 100 may include a telescope, one or more lenses, or one or more mirrors configured to expand, focus, or collimate the output beam 125 or the input beam 135 to a desired beam diameter or divergence. As an example, the lidar system 100 may include one or more lenses to focus the input beam 135 onto a photodetector of receiver 140. As another example, the lidar system 100 may include one or more flat mirrors or curved mirrors (e.g., concave, convex, or parabolic mirrors) to steer or focus the output beam 125 or the input beam 135. For example, the lidar system 100 may include an off-axis parabolic mirror to focus the input beam 135 onto a photodetector of receiver 140. As illustrated in FIG. 1, the lidar system 100 may include mirror 115 (which may be a metallic or dielectric mirror), and mirror 115 may be configured so that light beam 125 passes through the mirror 115 or passes along an edge or side of the mirror 115 and input beam 135 is reflected toward the receiver 140. As an example, mirror 115 (which may be referred to as an overlap mirror, superposition mirror, or beam-combiner mirror) may include a hole, slot, or aperture which output light beam 125 passes through. As another example, rather than passing through the mirror 115, the output beam 125 may be directed to pass alongside the mirror 115 with a gap (e.g., a gap of width approximately 0.1 mm, 0.5 mm, 1 mm, 2 mm, 5 mm, or 10 mm) between the output beam 125 and an edge of the mirror 115.

In particular embodiments, mirror 115 may provide for output beam 125 and input beam 135 to be substantially coaxial so that the two beams travel along approximately the same optical path (albeit in opposite directions). The input and output beams being substantially coaxial may refer to the beams being at least partially overlapped or sharing a common propagation axis so that input beam 135 and output beam 125 travel along substantially the same optical path (albeit in opposite directions). As an example, output beam 125 and input beam 135 may be parallel to each other to within less than 10 mrad, 5 mrad, 2 mrad, 1 mrad, 0.5 mrad, or 0.1 mrad. As output beam 125 is scanned across a field of regard, the input beam 135 may follow along with the output beam 125 so that the coaxial relationship between the two beams is maintained.

In particular embodiments, lidar system 100 may include a scanner 120 configured to scan an output beam 125 across a field of regard of the lidar system 100. As an example, scanner 120 may include one or more scanning mirrors configured to pivot, rotate, oscillate, or move in an angular manner about one or more rotation axes. The output beam 125 may be reflected by a scanning mirror, and as the scanning mirror pivots or rotates, the reflected output beam 125 may be scanned in a corresponding angular manner. As an example, a scanning mirror may be configured to periodically pivot back and forth over a 30-degree range, which results in the output beam 125 scanning back and forth across a 60-degree range (e.g., a Θ-degree rotation by a scanning mirror results in a 20-degree angular scan of output beam 125).

In particular embodiments, a scanning mirror (which may be referred to as a scan mirror) may be attached to or mechanically driven by a scanner actuator or mechanism which pivots or rotates the mirror over a particular angular range (e.g., over a 5° angular range, 30° angular range, 60° angular range, 120° angular range, 360° angular range, or any other suitable angular range). A scanner actuator or mechanism configured to pivot or rotate a mirror may include a galvanometer scanner, a resonant scanner, a piezoelectric actuator, a voice coil motor, an electric motor (e.g., a DC motor, a brushless DC motor, a synchronous electric motor, or a stepper motor), a microelectromechanical systems (MEMS) device, or any other suitable actuator or mechanism. As an example, a scanner 120 may include a scanning mirror attached to a galvanometer scanner configured to pivot back and forth over a 1° to 30° angular range. As another example, a scanner 120 may include a scanning mirror that is attached to or is part of a MEMS device configured to scan over a 1° to 30° angular range. As another example, a scanner 120 may include a polygon mirror configured to rotate continuously in the same direction (e.g., rather than pivoting back and forth, the polygon mirror continuously rotates 360 degrees in a clockwise or counterclockwise direction). The polygon mirror may be coupled or attached to a synchronous motor configured to rotate the polygon mirror at a substantially fixed rotational frequency (e.g., a rotational frequency of approximately 1 Hz, 10 Hz, 50 Hz, 100 Hz, 500 Hz, or 1,000 Hz).

In particular embodiments, scanner 120 may be configured to scan the output beam 125 (which may include at least a portion of the light emitted by light source 110) across a field of regard of the lidar system 100. A field of regard (FOR) of a lidar system 100 may refer to an area, region, or angular range over which the lidar system 100 may be configured to scan or capture distance information. As an example, a lidar system 100 with an output beam 125 with a 30-degree scanning range may be referred to as having a 30-degree angular field of regard. As another example, a lidar system 100 with a scanning mirror that rotates over a 30-degree range may produce an output beam 125 that scans across a 60-degree range (e.g., a 60-degree FOR). In particular embodiments, lidar system 100 may have a FOR of approximately 10°, 20°, 40°, 60°, 120°, 360°, or any other suitable FOR.

In particular embodiments, scanner 120 may be configured to scan the output beam 125 horizontally and vertically, and lidar system 100 may have a particular FOR along the horizontal direction and another particular FOR along the vertical direction. As an example, lidar system 100 may have a horizontal FOR of 10° to 120° and a vertical FOR of 2° to 45°. In particular embodiments, scanner 120 may include a first scan mirror and a second scan mirror, where the first scan mirror directs the output beam 125 toward the second scan mirror, and the second scan mirror directs the output beam 125 downrange from the lidar system 100. As an example, the first scan mirror may scan the output beam 125 along a first direction, and the second scan mirror may scan the output beam 125 along a second direction that is substantially orthogonal to the first direction. As another example, the first scan mirror may scan the output beam 125 along a substantially horizontal direction, and the second scan mirror may scan the output beam 125 along a substantially vertical direction (or vice versa). As another example, the first and second scan mirrors may each be driven by galvanometer scanners. As another example, the first or second scan mirror may include a polygon mirror driven by an electric motor. In particular embodiments, scanner 120 may be referred to as a beam scanner, optical scanner, or laser scanner.

In particular embodiments, one or more scanning mirrors may be communicatively coupled to controller 150 which may control the scanning mirror(s) so as to guide the output beam 125 in a desired direction downrange or along a desired scan pattern. In particular embodiments, a scan pattern may refer to a pattern or path along which the output beam 125 is directed. As an example, scanner 120 may include two scanning mirrors configured to scan the output beam 125 across a 60° horizontal FOR and a 20° vertical FOR. The two scanner mirrors may be controlled to follow a scan path that substantially covers the 60°×20° FOR. As an example, the scan path may result in a point cloud with pixels that substantially cover the 60°×20° FOR. The pixels may be approximately evenly distributed across the 60°×20° FOR. Alternatively, the pixels may have a particular nonuniform distribution (e.g., the pixels may be distributed across all or a portion of the 60°×20° FOR, and the pixels may have a higher density in one or more particular regions of the 60°×20° FOR).

In particular embodiments, a lidar system 100 may include a scanner 120 with a solid-state scanning device. A solid-state scanning device may refer to a scanner 120 that scans an output beam 125 without the use of moving parts (e.g., without the use of a mechanical scanner, such as a mirror that rotates or pivots). For example, a solid-state scanner 120 may include one or more of the following: an optical phased array scanning device; a liquid-crystal scanning device; or a liquid lens scanning device. A solid-state scanner 120 may be an electrically addressable device that scans an output beam 125 along one axis (e.g., horizontally) or along two axes (e.g., horizontally and vertically). In particular embodiments, a scanner 120 may include a solid-state scanner and a mechanical scanner. For example, a scanner 120 may include an optical phased array scanner configured to scan an output beam 125 in one direction and a galvanometer scanner that scans the output beam 125 in an orthogonal direction. The optical phased array scanner may scan the output beam relatively rapidly in a horizontal direction across the field of regard (e.g., at a scan rate of 50 to 1,000 scan lines per second), and the galvanometer may pivot a mirror at a rate of 1-30 Hz to scan the output beam 125 vertically.

In particular embodiments, a lidar system 100 may include a light source 110 configured to emit pulses of light and a scanner 120 configured to scan at least a portion of the emitted pulses of light across a field of regard of the lidar system 100. One or more of the emitted pulses of light may be scattered by a target 130 located downrange from the lidar system 100, and a receiver 140 may detect at least a portion of the pulses of light scattered by the target 130. A receiver 140 may be referred to as a photoreceiver, optical receiver, optical sensor, detector, photodetector, or optical detector. In particular embodiments, lidar system 100 may include a receiver 140 that receives or detects at least a portion of input beam 135 and produces an electrical signal that corresponds to input beam 135. As an example, if input beam 135 includes an optical pulse, then receiver 140 may produce an electrical current or voltage pulse that corresponds to the optical pulse detected by receiver 140. As another example, receiver 140 may include one or more avalanche photodiodes (APDs) or one or more single-photon avalanche diodes (SPADs). As another example, receiver 140 may include one or more PN photodiodes (e.g., a photodiode structure formed by a p-type semiconductor and an n-type semiconductor, where the PN acronym refers to the structure having p-doped and n-doped regions) or one or more PIN photodiodes (e.g., a photodiode structure formed by an undoped intrinsic semiconductor region located between p-type and n-type regions, where the PIN acronym refers to the structure having p-doped, intrinsic, and n-doped regions). An APD, SPAD, PN photodiode, or PIN photodiode may each be referred to as a detector, photodetector, or photodiode. A detector may have an active region or an avalanche-multiplication region that includes silicon, germanium, InGaAs, InAsSb (indium arsenide antimonide), AlAsSb (aluminum arsenide antimonide), or AlInAsSb (aluminum indium arsenide antimonide). The active region may refer to an area over which a detector may receive or detect input light. An active region may have any suitable size or diameter, such as for example, a diameter of approximately 10 μm, 25 μm, 50 μm, 80 μm, 100 μm, 200 μm, 500 μm, 1 mm, 2 mm, or 5 mm.

In particular embodiments, receiver 140 may include electronic circuitry that performs signal amplification, sampling, filtering, signal conditioning, analog-to-digital conversion, time-to-digital conversion, pulse detection, threshold detection, rising-edge detection, or falling-edge detection. As an example, receiver 140 may include a transimpedance amplifier that converts a received photocurrent (e.g., a current produced by an APD in response to a received optical signal) into a voltage signal. The voltage signal may be sent to pulse-detection circuitry that produces an analog or digital output signal 145 that corresponds to one or more optical characteristics (e.g., rising edge, falling edge, amplitude, duration, or energy) of a received optical pulse. As an example, the pulse-detection circuitry may perform a time-to-digital conversion to produce a digital output signal 145. The electrical output signal 145 may be sent to controller 150 for processing or analysis (e.g., to determine a time-of-flight value corresponding to a received optical pulse).

In particular embodiments, a controller 150 (which may include or may be referred to as a processor, an FPGA, an ASIC, a computer, or a computing system) may be located within a lidar system 100 or outside of a lidar system 100. Alternatively, one or more parts of a controller 150 may be located within a lidar system 100, and one or more other parts of a controller 150 may be located outside a lidar system 100. In particular embodiments, one or more parts of a controller 150 may be located within a receiver 140 of a lidar system 100, and one or more other parts of a controller 150 may be located in other parts of the lidar system 100. For example, a receiver 140 may include an FPGA or ASIC configured to process an output electrical signal from the receiver 140, and the processed signal may be sent to a computing system located elsewhere within the lidar system 100 or outside the lidar system 100. In particular embodiments, a controller 150 may include any suitable arrangement or combination of logic circuitry, analog circuitry, or digital circuitry.

In particular embodiments, controller 150 may be electrically coupled or communicatively coupled to light source 110, scanner 120, or receiver 140. As an example, controller 150 may receive electrical trigger pulses or edges from light source 110, where each pulse or edge corresponds to the emission of an optical pulse by light source 110. As another example, controller 150 may provide instructions, a control signal, or a trigger signal to light source 110 indicating when light source 110 should produce optical pulses. Controller 150 may send an electrical trigger signal that includes electrical pulses, where each electrical pulse results in the emission of an optical pulse by light source 110. In particular embodiments, the frequency, period, duration, pulse energy, peak power, average power, or wavelength of the optical pulses produced by light source 110 may be adjusted based on instructions, a control signal, or trigger pulses provided by controller 150. In particular embodiments, controller 150 may be coupled to light source 110 and receiver 140, and controller 150 may determine a time-of-flight value for an optical pulse based on timing information associated with when the pulse was emitted by light source 110 and when a portion of the pulse (e.g., input beam 135) was detected or received by receiver 140. In particular embodiments, controller 150 may include circuitry that performs signal amplification, sampling, filtering, signal conditioning, analog-to-digital conversion, time-to-digital conversion, pulse detection, threshold detection, rising-edge detection, or falling-edge detection.

In particular embodiments, lidar system 100 may include one or more processors (e.g., a controller 150) configured to determine a distance D from the lidar system 100 to a target 130 based at least in part on a round-trip time of flight for an emitted pulse of light to travel from the lidar system 100 to the target 130 and back to the lidar system 100. The target 130 may be at least partially contained within a field of regard of the lidar system 100 and located a distance D from the lidar system 100 that is less than or equal to an operating range (R_{OP}) of the lidar system 100. In particular embodiments, an operating range (which may be referred to as an operating distance) of a lidar system 100 may refer to a distance over which the lidar system 100 is configured to sense or identify targets 130 located within a field of regard of the lidar system 100. The operating range of lidar system 100 may be any suitable distance, such as for example, 25 m, 50 m, 100 m, 200 m, 250 m, 500 m, or 1 km. As an example, a lidar system 100 with a 200-m operating range may be configured to sense or identify various targets 130 located up to 200 m away from the lidar system 100. The operating range R_{OP} of a lidar system 100 may be related to the time t between the emission of successive optical signals by the expression R_{OP}=c·τ/2. For a lidar system 100 with a 200-m operating range (R_{OP}=200 m), the time τ between successive pulses (which may be referred to as a pulse period, a pulse repetition interval (PRI), or a time period between pulses) is approximately 2·R_{OP}/c=1.33 μs. The pulse period t may also correspond to the time of flight for a pulse to travel to and from a target 130 located a distance R_{OP} from the lidar system 100. Additionally, the pulse period t may be related to the pulse repetition frequency (PRF) by the expression τ=1/PRF. For example, a pulse period of 1.33 μs corresponds to a PRF of approximately 752 kHz.

In particular embodiments, a lidar system 100 may be used to determine the distance to one or more downrange targets 130. By scanning the lidar system 100 across a field of regard, the system may be used to map the distance to a number of points within the field of regard. Each of these depth-mapped points may be referred to as a pixel or a voxel. A collection of pixels captured in succession (which may be referred to as a depth map, a point cloud, or a frame) may be rendered as an image or may be analyzed to identify or detect objects or to determine a shape or distance of objects within the FOR. As an example, a point cloud may cover a field of regard that extends 60° horizontally and 15° vertically, and the point cloud may include a frame of 100-2000 pixels in the horizontal direction by 4-400 pixels in the vertical direction.

In particular embodiments, a lidar system 100 may be used to determine the existence of one or more blocking contaminants on sensor window 157 of lidar system 100. Blocking contaminants can impact the ability of lidar system 100 to determine the existence and/or distance to one or more downrange targets 130. Depending on the severity of the influence of the blocking contaminants, the resulting point cloud from mapping downrange objects within the field of regard is impacted and the accuracy of the depth-mapped points can significantly decrease. By identifying the existence of blocking contaminants, lidar system 100 can be modified to compensate for the contaminants. For example, lidar system 100 can trigger a cleaning process to clear any blocking contaminants from sensor window 157 of lidar system 100. As another example, in the scenario where sensor window 157 is permanently damaged, lidar system 100 can trigger a maintenance process such as a process to replace sensor window 157, to disable regions within the field of regard from mapping, and/or to rely on a secondary lidar system for mapping certain regions. These approaches can be an effective solution in the event sensor window 157 is severely damaged.

In particular embodiments, lidar system 100 may be configured to repeatedly capture or generate point clouds of a field of regard at any suitable frame rate between approximately 0.1 frames per second (FPS) and approximately 1,000 FPS. As an example, lidar system 100 may generate point clouds at a frame rate of approximately 0.1 FPS, 0.5 FPS, 1 FPS, 2 FPS, 5 FPS, 10 FPS, 20 FPS, 100 FPS, 500 FPS, or 1,000 FPS. As another example, lidar system 100 may be configured to produce optical pulses at a rate of 5×10⁵ pulses/second (e.g., the system may determine 500,000 pixel distances per second) and scan a frame of 1000×50 pixels (e.g., 50,000 pixels/frame), which corresponds to a point-cloud frame rate of 10 frames per second (e.g., 10 point clouds per second). In particular embodiments, a point-cloud frame rate may be substantially fixed, or a point-cloud frame rate may be dynamically adjustable. As an example, a lidar system 100 may capture one or more point clouds at a particular frame rate (e.g., 1 Hz) and then switch to capture one or more point clouds at a different frame rate (e.g., 10 Hz). A slower frame rate (e.g., 1 Hz) may be used to capture one or more high-resolution point clouds, and a faster frame rate (e.g., 10 Hz) may be used to rapidly capture multiple lower-resolution point clouds.

In particular embodiments, a lidar system 100 may be configured to sense, identify, or determine distances to one or more targets 130 within a field of regard. As an example, a lidar system 100 may determine a distance to a target 130, where all or part of the target 130 is contained within a field of regard of the lidar system 100. All or part of a target 130 being contained within a FOR of the lidar system 100 may refer to the FOR overlapping, encompassing, or enclosing at least a portion of the target 130. In particular embodiments, target 130 may include all or part of an object that is moving or stationary relative to lidar system 100. As an example, target 130 may include all or a portion of a person, vehicle, motorcycle, truck, train, bicycle, wheelchair, pedestrian, animal, road sign, traffic light, lane marking, road-surface marking, parking space, pylon, guard rail, traffic barrier, pothole, railroad crossing, obstacle in or near a road, curb, stopped vehicle on or beside a road, utility pole, house, building, trash can, mailbox, tree, any other suitable object, or any suitable combination of all or part of two or more objects. In particular embodiments, a target may be referred to as an object.

In particular embodiments, light source 110, scanner 120, and receiver 140 may be packaged together within a single housing, where a housing may refer to a box, case, or enclosure that includes sensor window 157 and holds or contains all or part of a lidar system 100. As an example, a lidar-system enclosure may contain a light source 110, mirror 115, scanner 120, and receiver 140 of a lidar system 100. Additionally, the lidar-system enclosure may include a controller 150. The lidar-system enclosure may also include one or more electrical connections for conveying electrical power or electrical signals to or from the enclosure. In particular embodiments, one or more components of a lidar system 100 may be located remotely from a lidar-system enclosure. As an example, all or part of light source 110 may be located remotely from a lidar-system enclosure, and pulses of light produced by the light source 110 may be conveyed to the enclosure via optical fiber. As another example, all or part of a controller 150 may be located remotely from a lidar-system enclosure.

In particular embodiments, light source 110 may include an eye-safe laser, or lidar system 100 may be classified as an eye-safe laser system or laser product. An eye-safe laser, laser system, or laser product may refer to a system that includes a laser with an emission wavelength, average power, peak power, peak intensity, pulse energy, beam size, beam divergence, exposure time, or scanned output beam such that emitted light from the system presents little or no possibility of causing damage to a person's eyes. As an example, light source 110 or lidar system 100 may be classified as a Class I laser product (as specified by the 60825-1:2014 standard of the International Electrotechnical Commission (IEC)) or a Class I laser product (as specified by Title 21, Section 1040.10 of the United States Code of Federal Regulations (CFR)) that is safe under all conditions of normal use. In particular embodiments, lidar system 100 may be an eye-safe laser product (e.g., with a Class 1 or Class I classification) configured to operate at any suitable wavelength between approximately 900 nm and approximately 2100 nm. As an example, lidar system 100 may include a laser with an operating wavelength between approximately 1200 nm and approximately 1400 nm or between approximately 1400 nm and approximately 1600 nm, and the laser or the lidar system 100 may be operated in an eye-safe manner. As another example, lidar system 100 may be an eye-safe laser product that includes a scanned laser with an operating wavelength between approximately 900 nm and approximately 1700 nm. As another example, lidar system 100 may be a Class 1 or Class I laser product that includes a laser diode, fiber laser, or solid-state laser with an operating wavelength between approximately 1200 nm and approximately 1600 nm. As another example, lidar system 100 may have an operating wavelength between approximately 1500 nm and approximately 1510 nm.

In particular embodiments, one or more lidar systems 100 may be integrated into a vehicle. As an example, multiple lidar systems 100 may be integrated into a car to provide a complete 360-degree horizontal FOR around the car. As another example, 2-10 lidar systems 100, each system having a 45-degree to 180-degree horizontal FOR, may be combined together to form a sensing system that provides a point cloud covering a 360-degree horizontal FOR. The lidar systems 100 may be oriented so that adjacent FORs have an amount of spatial or angular overlap to allow data from the multiple lidar systems 100 to be combined or stitched together to form a single or continuous 360-degree point cloud. As an example, the FOR of each lidar system 100 may have approximately 1-30 degrees of overlap with an adjacent FOR. In particular embodiments, a vehicle may refer to a mobile machine configured to transport people or cargo. For example, a vehicle may include, may take the form of, or may be referred to as a car, automobile, motor vehicle, truck, bus, van, trailer, off-road vehicle, farm vehicle, lawn mower, construction equipment, forklift, robot, golf cart, motorhome, taxi, motorcycle, scooter, bicycle, skateboard, train, snowmobile, watercraft (e.g., a ship or boat), aircraft (e.g., a fixed-wing aircraft, helicopter, or dirigible), unmanned aerial vehicle (e.g., drone), or spacecraft. In particular embodiments, a vehicle may include an internal combustion engine or an electric motor that provides propulsion for the vehicle.

In particular embodiments, one or more lidar systems 100 may be included in a vehicle as part of an advanced driver assistance system (ADAS) to assist a driver of the vehicle in operating the vehicle. For example, a lidar system 100 may be part of an ADAS that provides information (e.g., about the surrounding environment) or feedback to a driver (e.g., to alert the driver to potential problems or hazards) or that automatically takes control of part of a vehicle (e.g., a braking system or a steering system) to avoid collisions or accidents. A lidar system 100 may be part of a vehicle ADAS that provides adaptive cruise control, automated braking, automated parking, collision avoidance, alerts the driver to hazards or other vehicles, maintains the vehicle in the correct lane, or provides a warning if an object or another vehicle is in a blind spot.

In particular embodiments, one or more lidar systems 100 may be integrated into a vehicle as part of an autonomous-vehicle driving system. As an example, a lidar system 100 may provide information about the surrounding environment to a driving system of an autonomous vehicle. An autonomous-vehicle driving system may be configured to guide the autonomous vehicle through an environment surrounding the vehicle and toward a destination. An autonomous-vehicle driving system may include one or more computing systems that receive information from a lidar system 100 about the surrounding environment, analyze the received information, and provide control signals to the vehicle's driving systems (e.g., steering mechanism, accelerator, brakes, lights, or turn signals). As an example, a lidar system 100 integrated into an autonomous vehicle may provide an autonomous-vehicle driving system with a point cloud every 0.1 seconds (e.g., the point cloud has a 10 Hz update rate, representing 10 frames per second). The autonomous-vehicle driving system may analyze the received point clouds to sense or identify targets 130 and their respective locations, distances, or speeds, and the autonomous-vehicle driving system may update control signals based on this information. As an example, if lidar system 100 detects a vehicle ahead that is slowing down or stopping, the autonomous-vehicle driving system may send instructions to release the accelerator and apply the brakes.

In particular embodiments, an autonomous vehicle may be referred to as an autonomous car, driverless car, self-driving car, robotic car, or unmanned vehicle. In particular embodiments, an autonomous vehicle may refer to a vehicle configured to sense its environment and navigate or drive with little or no human input. As an example, an autonomous vehicle may be configured to drive to any suitable location and control or perform all safety-critical functions (e.g., driving, steering, braking, parking) for the entire trip, with the driver not expected to control the vehicle at any time. As another example, an autonomous vehicle may allow a driver to safely turn their attention away from driving tasks in particular environments (e.g., on freeways), or an autonomous vehicle may provide control of a vehicle in all but a few environments, requiring little or no input or attention from the driver.

In particular embodiments, an autonomous vehicle may be configured to drive with a driver present in the vehicle, or an autonomous vehicle may be configured to operate the vehicle with no driver present. As an example, an autonomous vehicle may include a driver's seat with associated controls (e.g., steering wheel, accelerator pedal, and brake pedal), and the vehicle may be configured to drive with no one seated in the driver's seat or with little or no input from a person seated in the driver's seat. As another example, an autonomous vehicle may not include any driver's seat or associated driver's controls, and the vehicle may perform substantially all driving functions (e.g., driving, steering, braking, parking, and navigating) without human input. As another example, an autonomous vehicle may be configured to operate without a driver (e.g., the vehicle may be configured to transport human passengers or cargo without a driver present in the vehicle). As another example, an autonomous vehicle may be configured to operate without any human passengers (e.g., the vehicle may be configured for transportation of cargo without having any human passengers onboard the vehicle).

In particular embodiments, an optical signal (which may be referred to as a light signal, a light waveform, an optical waveform, an output beam, an emitted optical signal, or emitted light) may include pulses of light, CW light, amplitude-modulated light, frequency-modulated (FM) light, or any suitable combination thereof. Although this disclosure describes or illustrates example embodiments of lidar systems 100 or light sources 110 that produce optical signals that include pulses of light, the embodiments described or illustrated herein may also be applied, where appropriate, to other types of optical signals, including continuous-wave (CW) light, amplitude-modulated optical signals, or frequency-modulated optical signals. For example, a lidar system 100 as described or illustrated herein may be a pulsed lidar system and may include a light source 110 that produces pulses of light. Alternatively, a lidar system 100 may be configured to operate as a frequency-modulated continuous-wave (FMCW) lidar system and may include a light source 110 that produces CW light or a frequency-modulated optical signal.

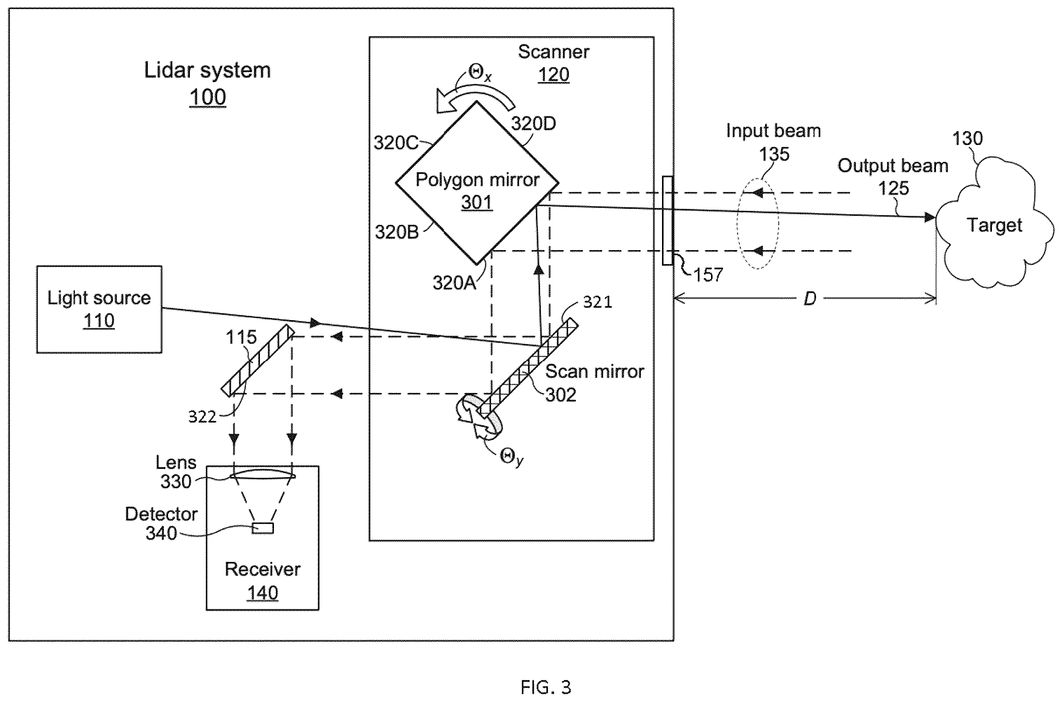

In particular embodiments, a lidar system 100 may be an FMCW lidar system where the emitted light from the light source 110 (e.g., output beam 125 in FIG. 1 or FIG. 3) includes frequency-modulated light. A pulsed lidar system is a type of lidar system 100 in which the light source 110 emits pulses of light, and the distance to a remote target 130 is determined based on the round-trip time-of-flight for a pulse of light to travel to the target 130 and back. Another type of lidar system 100 is a frequency-modulated lidar system, which may be referred to as a frequency-modulated continuous-wave (FMCW) lidar system. An FMCW lidar system uses frequency-modulated light to determine the distance to a remote target 130 based on a frequency of received light (which includes emitted light scattered by the remote target) relative to a frequency of local-oscillator (LO) light. A round-trip time for the emitted light to travel to a target 130 and back to the lidar system may correspond to a frequency difference between the received scattered light and the LO light. A larger frequency difference may correspond to a longer round-trip time and a greater distance to the target 130.

A light source 110 for a FMCW lidar system may include (i) a direct-emitter laser diode, (ii) a seed laser diode followed by an SOA, (iii) a seed laser diode followed by a fiber-optic amplifier, or (iv) a seed laser diode followed by an SOA and then a fiber-optic amplifier. A seed laser diode or a direct-emitter laser diode may be operated in a CW manner (e.g., by driving the laser diode with a substantially constant DC current), and a frequency modulation may be provided by an external modulator (e.g., an electro-optic phase modulator may apply a frequency modulation to seed-laser light). Alternatively, a frequency modulation may be produced by applying a current modulation to a seed laser diode or a direct-emitter laser diode. The current modulation (which may be provided along with a DC bias current) may produce a corresponding refractive-index modulation in the laser diode, which results in a frequency modulation of the light emitted by the laser diode. The current-modulation component (and the corresponding frequency modulation) may have any suitable frequency or shape (e.g., piecewise linear, sinusoidal, triangle-wave, or sawtooth). For example, the current-modulation component (and the resulting frequency modulation of the emitted light) may increase or decrease monotonically over a particular time interval. As another example, the current-modulation component may include a triangle or sawtooth wave with an electrical current that increases or decreases linearly over a particular time interval, and the light emitted by the laser diode may include a corresponding frequency modulation in which the optical frequency increases or decreases approximately linearly over the particular time interval. For example, a light source 110 that emits light with a linear frequency change of 200 MHz over a 2-μs time interval may be referred to as having a frequency modulation m of 1014 Hz/s (or, 100 MHz/us).

In addition to producing frequency-modulated emitted light, a light source 110 may also produce frequency-modulated local-oscillator (LO) light. The LO light may be coherent with the emitted light, and the frequency modulation of the LO light may match that of the emitted light. The LO light may be produced by splitting off a portion of the emitted light prior to the emitted light exiting the lidar system. Alternatively, the LO light may be produced by a seed laser diode or a direct-emitter laser diode that is part of the light source 110. For example, the LO light may be emitted from the back facet of a seed laser diode or a direct-emitter laser diode, or the LO light may be split off from the seed light emitted from the front facet of a seed laser diode. The received light (e.g., emitted light that is scattered by a target 130) and the LO light may each be frequency modulated, with a frequency difference or offset that corresponds to the distance to the target 130. For a linearly chirped light source (e.g., a frequency modulation that produces a linear change in frequency with time), the larger the frequency difference is between the received light and the LO light, the farther away the target 130 is located.

A frequency difference between received light and LO light may be determined by mixing the received light with the LO light (e.g., by coupling the two beams onto a detector so they are coherently mixed together at the detector) and determining the resulting beat frequency. For example, a photocurrent signal produced by an APD may include a beat signal resulting from the coherent mixing of the received light and the LO light, and a frequency of the beat signal may correspond to the frequency difference between the received light and the LO light. The photocurrent signal from an APD (or a voltage signal that corresponds to the photocurrent signal) may be analyzed using a frequency-analysis technique (e.g., a fast Fourier transform (FFT) technique) to determine the frequency of the beat signal. If a linear frequency modulation m (e.g., in units of Hz/s) is applied to a CW laser, then the round-trip time T may be related to the frequency difference Δf between the received scattered light and the LO light by the expression T=Δf/m. Additionally, the distance D from the target 130 to the lidar system 100 may be expressed as D=(Δf/m)·c/2, where c is the speed of light. For example, for a light source 110 with a linear frequency modulation of 1014 Hz/s, if a frequency difference (between the received scattered light and the LO light) of 33 MHz is measured, then this corresponds to a round-trip time of approximately 330 ns and a distance to the target of approximately 50 meters. As another example, a frequency difference of 133 MHz corresponds to a round-trip time of approximately 1.33 us and a distance to the target of approximately 200 meters. A receiver or processor of an FMCW lidar system may determine a frequency difference between received scattered light and LO light, and the distance to a target may be determined based on the frequency difference. The frequency difference Δf between received scattered light and LO light corresponds to the round-trip time T (e.g., through the relationship T=Δf/m), and determining the frequency difference may correspond to or may be referred to as determining the round-trip time.

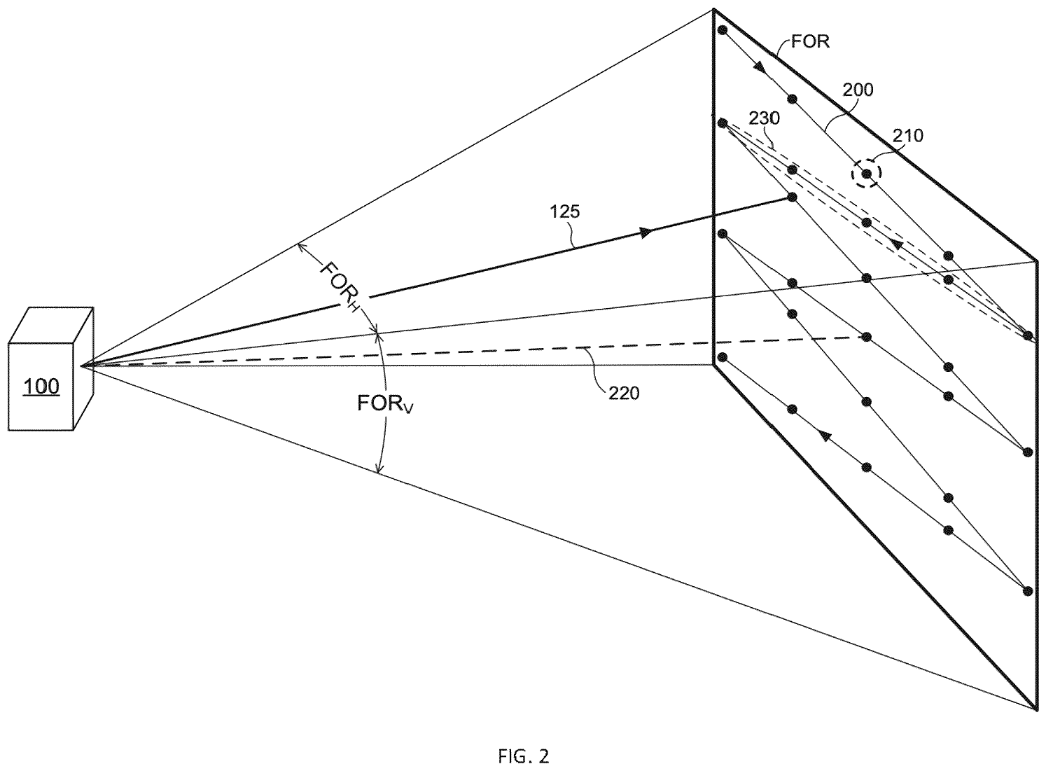

FIG. 2 illustrates an example scan pattern 200 produced by a lidar system 100. A scanner 120 of the lidar system 100 may scan the output beam 125 (which may include multiple emitted optical signals) along a scan pattern 200 that is contained within a FOR of the lidar system 100. A scan pattern 200 (which may be referred to as an optical scan pattern, optical scan path, scan path, or scan) may represent a path or course followed by output beam 125 as it is scanned across all or part of a FOR. Each traversal of a scan pattern 200 may correspond to the capture of a single frame or a single point cloud. In particular embodiments, a lidar system 100 may be configured to scan output optical beam 125 along one or more particular scan patterns 200. In particular embodiments, a scan pattern 200 may scan across any suitable field of regard (FOR) having any suitable horizontal FOR (FOR_{H}) and any suitable vertical FOR (FOR_{V}). For example, a scan pattern 200 may have a field of regard represented by angular dimensions (e.g., FOR_{H}×FOR_{V}) 40°×30°, 90°×40°, or 60°×15°. As another example, a scan pattern 200 may have a FOR_{H} greater than or equal to 10°, 25°, 30°, 40°, 60°, 90°, or 120°. As another example, a scan pattern 200 may have a FOR_{V} greater than or equal to 2°, 5°, 10°, 15°, 20°, 30°, or 45°.

In the example of FIG. 2, reference line 220 represents a center of the field of regard of scan pattern 200. In particular embodiments, reference line 220 may have any suitable orientation, such as for example, a horizontal angle of 0° (e.g., reference line 220 may be oriented straight ahead) and a vertical angle of 0° (e.g., reference line 220 may have an inclination of) 0°, or reference line 220 may have a nonzero horizontal angle or a nonzero inclination (e.g., a vertical angle of +10° or −10°). In FIG. 2, if the scan pattern 200 has a 60°×15° field of regard, then scan pattern 200 covers a ±30° horizontal range with respect to reference line 220 and a ±7.5° vertical range with respect to reference line 220. Additionally, optical beam 125 in FIG. 2 has an orientation of approximately −15° horizontal and +3° vertical with respect to reference line 220. Optical beam 125 may be referred to as having an azimuth of −15° and an altitude of +3° relative to reference line 220. In particular embodiments, an azimuth (which may be referred to as an azimuth angle) may represent a horizontal angle with respect to reference line 220, and an altitude (which may be referred to as an altitude angle, elevation, or elevation angle) may represent a vertical angle with respect to reference line 220.

In particular embodiments, a scan pattern 200 may include multiple pixels 210, and each pixel 210 may be associated with one or more laser pulses or one or more distance measurements. Additionally, a scan pattern 200 may include multiple scan lines 230, where each scan line represents one scan across at least part of a field of regard, and each scan line 230 may include multiple pixels 210. In FIG. 2, scan line 230 includes five pixels 210 and corresponds to an approximately horizontal scan across the FOR from right to left, as viewed from the lidar system 100. In particular embodiments, a cycle of scan pattern 200 may include a total of Pₓ×P_{y} pixels 210 (e.g., a two-dimensional distribution of Pₓ by P_{y} pixels). As an example, scan pattern 200 may include a distribution with dimensions of approximately 100-2,000 pixels 210 along a horizontal direction and approximately 4-400 pixels 210 along a vertical direction. As another example, scan pattern 200 may include a distribution of 1,000 pixels 210 along the horizontal direction by 64 pixels 210 along the vertical direction (e.g., the frame size is 1000×64 pixels) for a total of 64,000 pixels per cycle of scan pattern 200. In particular embodiments, the number of pixels 210 along a horizontal direction may be referred to as a horizontal resolution of scan pattern 200, and the number of pixels 210 along a vertical direction may be referred to as a vertical resolution. As an example, scan pattern 200 may have a horizontal resolution of greater than or equal to 100 pixels 210 and a vertical resolution of greater than or equal to 4 pixels 210. As another example, scan pattern 200 may have a horizontal resolution of 100-2,000 pixels 210 and a vertical resolution of 4-400 pixels 210.

In particular embodiments, a pixel 210 may refer to a data element that includes (i) distance information (e.g., a distance from a lidar system 100 to a target 130 from which an associated pulse of light was scattered) or (ii) an elevation angle and an azimuth angle associated with the pixel (e.g., the elevation and azimuth angles along which the associated pulse of light was emitted). Each pixel 210 may be associated with a distance (e.g., a distance to a portion of a target 130 from which an associated laser pulse was scattered) or one or more angular values. As an example, a pixel 210 may be associated with a distance value and two angular values (e.g., an azimuth and altitude) that represent the angular location of the pixel 210 with respect to the lidar system 100. A distance to a portion of target 130 may be determined based at least in part on a time-of-flight measurement for a corresponding pulse. An angular value (e.g., an azimuth or altitude) may correspond to an angle (e.g., relative to reference line 220) of output beam 125 (e.g., when a corresponding pulse is emitted from lidar system 100) or an angle of input beam 135 (e.g., when an input signal is received by lidar system 100). In particular embodiments, an angular value may be determined based at least in part on a position of a component of scanner 120. As an example, an azimuth or altitude value associated with a pixel 210 may be determined from an angular position of one or more corresponding scanning mirrors of scanner 120.

FIG. 3 illustrates an example lidar system 100 with an example rotating polygon mirror 301. In particular embodiments, a scanner 120 may include a polygon mirror 301 configured to scan output beam 125 along a particular direction. In the example of FIG. 3, scanner 120 includes two scanning mirrors: (1) a polygon mirror 301 that rotates along the Ox direction and (2) a scanning mirror 302 that oscillates back and forth along the Θ_{y} direction. The output beam 125 from light source 110, which passes alongside mirror 115, is reflected by reflecting surface 321 of scan mirror 302, is then reflected by a reflecting surface (e.g., surface 320A, 320B, 320C, or 320D) of polygon mirror 301, and then passes through sensor window 157. Scattered light from a target 130 returns to the lidar system 100 as input beam 135. The input beam 135 passes through sensor window 157 and then reflects from polygon mirror 301, scan mirror 302, and mirror 115, which directs input beam 135 through focusing lens 330 and to the detector 340 of receiver 140. As shown in FIG. 3, scan mirror 302 includes reflecting surface 321 and mirror 115 includes reflecting surface 322. The detector 340 may be a PN photodiode, a PIN photodiode, an APD, an SPAD, or any other suitable detector. A reflecting surface 320 (which may be referred to as a reflective surface) may include a reflective metallic coating (e.g., gold, silver, or aluminum) or a reflective dielectric coating, and the reflecting surface 320 may have any suitable reflectivity R at an operating wavelength of the light source 110 (e.g., R greater than or equal to 70%, 80%, 90%, 95%, 98%, or 99%). In the event sensor window 157 contains a blocking contaminant (not shown), portions of output beam 125 may not reach target 130 but are instead scattered or reflected by the blocking contaminant. Some of the scattered or reflected light from the blockage may return toward the lidar system 100 along a similar path to input beam 135. For example, at least a portion of the light scattered or reflected by the blocking contaminant passes through at least a portion of sensor window 157 and then reflects from polygon mirror 301, scan mirror 302, and mirror 115, which directs the returning beam through focusing lens 330 and to the detector 340 of receiver 140.

In particular embodiments, a polygon mirror 301 may be configured to rotate along a Θₓ or Θ_{y} direction and scan output beam 125 along a substantially horizontal or vertical direction, respectively. A rotation along a Θₓ direction may refer to a rotational motion of mirror 301 that results in output beam 125 scanning along a substantially horizontal direction. Similarly, a rotation along a Θ_{y} direction may refer to a rotational motion that results in output beam 125 scanning along a substantially vertical direction. In FIG. 3, mirror 301 is a polygon mirror that rotates along the Θₓ direction and scans output beam 125 along a substantially horizontal direction, and mirror 302 pivots along the Θ_{y} direction and scans output beam 125 along a substantially vertical direction. In particular embodiments, a polygon mirror 301 may be configured to scan output beam 125 along any suitable direction. As an example, a polygon mirror 301 may scan output beam 125 at any suitable angle with respect to a horizontal or vertical direction, such as for example, at an angle of approximately 0°, 10°, 20°, 30°, 45°, 60°, 70°, 80°, or 90° with respect to a horizontal or vertical direction.

In particular embodiments, a polygon mirror 301 may refer to a multi-sided object having reflective surfaces 320 on two or more of its sides or faces. As an example, a polygon mirror may include any suitable number of reflective faces (e.g., 2, 3, 4, 5, 6, 7, 8, or 10 faces), where each face includes a reflective surface 320. A polygon mirror 301 may have a cross-sectional shape of any suitable polygon, such as for example, a triangle (with three reflecting surfaces 320), square (with four reflecting surfaces 320), pentagon (with five reflecting surfaces 320), hexagon (with six reflecting surfaces 320), heptagon (with seven reflecting surfaces 320), or octagon (with eight reflecting surfaces 320). In FIG. 3, the polygon mirror 301 has a substantially square cross-sectional shape and four reflecting surfaces (320A, 320B, 320C, and 320D). The polygon mirror 301 in FIG. 3 may be referred to as a square mirror, a cube mirror, or a four-sided polygon mirror. In FIG. 3, the polygon mirror 301 may have a shape similar to a cube, cuboid, or rectangular prism. Additionally, the polygon mirror 301 may have a total of six sides, where four of the sides include faces with reflective surfaces (320A, 320B, 320C, and 320D).

In particular embodiments, a polygon mirror 301 may be continuously rotated in a clockwise or counter-clockwise rotation direction about a rotation axis of the polygon mirror 301. The rotation axis may correspond to a line that is perpendicular to the plane of rotation of the polygon mirror 301 and that passes through the center of mass of the polygon mirror 301. In FIG. 3, the polygon mirror 301 rotates in the plane of the drawing, and the rotation axis of the polygon mirror 301 is perpendicular to the plane of the drawing. An electric motor may be configured to rotate a polygon mirror 301 at a substantially fixed frequency (e.g., a rotational frequency of approximately 1 Hz (or 1 revolution per second), 10 Hz, 50 Hz, 100 Hz, 500 Hz, or 1,000 Hz). As an example, a polygon mirror 301 may be mechanically coupled to an electric motor (e.g., a synchronous electric motor) which is configured to spin the polygon mirror 301 at a rotational speed of approximately 160 Hz (or, 9600 revolutions per minute (RPM)).

In particular embodiments, output beam 125 may be reflected sequentially from the reflective surfaces 320A, 320B, 320C, and 320D as the polygon mirror 301 is rotated. This results in the output beam 125 being scanned along a particular scan axis (e.g., a horizontal or vertical scan axis) to produce a sequence of scan lines, where each scan line corresponds to a reflection of the output beam 125 from one of the reflective surfaces of the polygon mirror 301. In FIG. 3, the output beam 125 reflects off of reflective surface 320A to produce one scan line. Then, as the polygon mirror 301 rotates, the output beam 125 reflects off of reflective surfaces 320B, 320C, and 320D to produce a second, third, and fourth respective scan line. In particular embodiments, a lidar system 100 may be configured so that the output beam 125 is first reflected from polygon mirror 301 and then from scan mirror 302 (or vice versa). As an example, an output beam 125 from light source 110 may first be directed to polygon mirror 301, where it is reflected by a reflective surface of the polygon mirror 301, and then the output beam 125 may be directed to scan mirror 302, where it is reflected by reflective surface 321 of the scan mirror 302. In the example of FIG. 3, the output beam 125 is reflected from the polygon mirror 301 and the scan mirror 302 in the reverse order. In FIG. 3, the output beam 125 from light source 110 is first directed to the scan mirror 302, where it is reflected by reflective surface 321, and then the output beam 125 is directed to the polygon mirror 301, where it is reflected by reflective surface 320A.

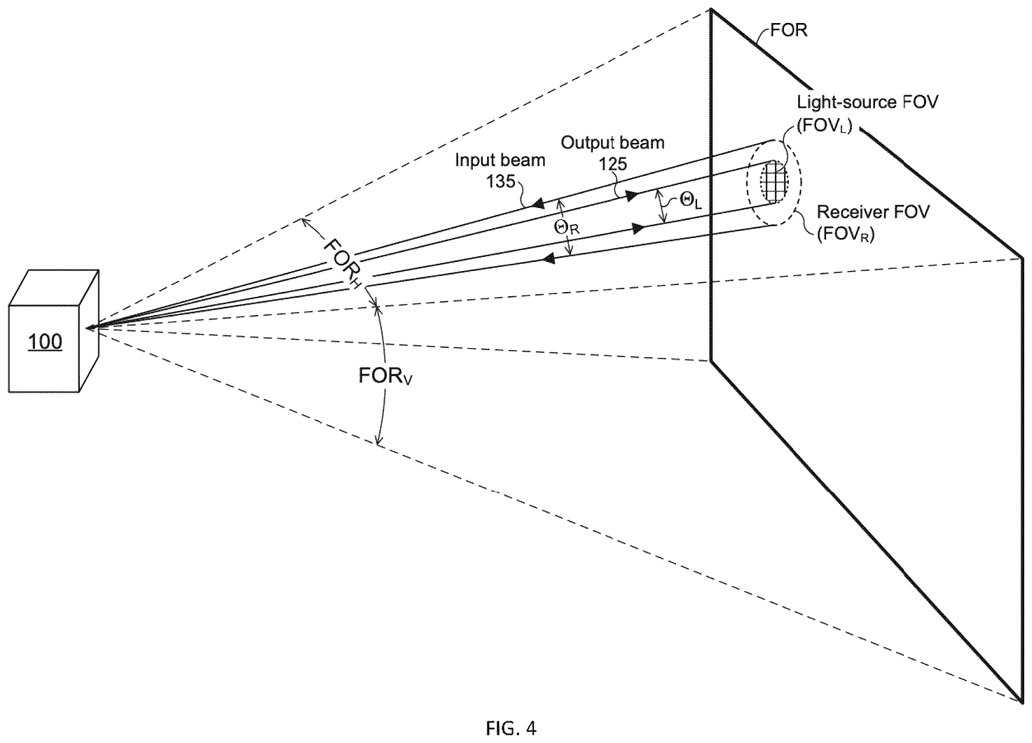

FIG. 4 illustrates an example light-source field of view (FOV_{L}) and receiver field of view (FOV_{R}) for a lidar system 100. A light source 110 of lidar system 100 may emit pulses of light as the FOV_{L} and FOV_{R} are scanned by scanner 120 across a field of regard (FOR). In particular embodiments, a light-source field of view may refer to an angular cone illuminated by the light source 110 at a particular instant of time. Similarly, a receiver field of view may refer to an angular cone over which the receiver 140 may receive or detect light at a particular instant of time, and any light outside the receiver field of view may not be received or detected. As an example, as the light-source field of view is scanned across a field of regard, a portion of a pulse of light emitted by the light source 110 may be sent downrange from lidar system 100, and the pulse of light may be sent in the direction that the FOV_{L} is pointing at the time the pulse is emitted. The pulse of light may scatter off a target 130, and the receiver 140 may receive and detect a portion of the scattered light that is directed along or contained within the FOV_{R}.

In particular embodiments, scanner 120 may be configured to scan both a light-source field of view and a receiver field of view across a field of regard of the lidar system 100. Multiple pulses of light may be emitted and detected as the scanner 120 scans the FOV_{L} and FOV_{R} across the field of regard of the lidar system 100 while tracing out a scan pattern 200. In particular embodiments, the light-source field of view and the receiver field of view may be scanned synchronously with respect to one another, so that as the FOV_{L} is scanned across a scan pattern 200, the FOV_{R} follows substantially the same path at the same scanning speed. Additionally, the FOV_{L} and FOV_{R} may maintain the same relative position to one another as they are scanned across the field of regard. As an example, the FOV_{L} may be substantially overlapped with or centered inside the FOV_{R} (as illustrated in FIG. 4), and this relative positioning between FOV_{L} and FOV_{R} may be maintained throughout a scan. As another example, the FOV_{R} may lag behind the FOV_{L} by a particular, fixed amount throughout a scan (e.g., the FOV_{R} may be offset from the FOV_{L} in a direction opposite the scan direction).

In particular embodiments, the FOV_{L} may have an angular size or extent Θ_{L} that is substantially the same as or that corresponds to the divergence of the output beam 125, and the FOV_{R} may have an angular size or extent Θ_{R} that corresponds to an angle over which the receiver 140 may receive and detect light. In particular embodiments, the receiver field of view may be any suitable size relative to the light-source field of view. As an example, the receiver field of view may be smaller than, substantially the same size as, or larger than the angular extent of the light-source field of view. In particular embodiments, the light-source field of view may have an angular extent of less than or equal to 50 milliradians, and the receiver field of view may have an angular extent of less than or equal to 50 milliradians. The FOV_{L} may have any suitable angular extent Θ_{L}, such as for example, approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. Similarly, the FOV_{R} may have any suitable angular extent Θ_{R}, such as for example, approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. In particular embodiments, the light-source field of view and the receiver field of view may have approximately equal angular extents. As an example, Θ_{L} and Θ_{R} may both be approximately equal to 1 mrad, 2 mrad, or 4 mrad. In particular embodiments, the receiver field of view may be larger than the light-source field of view, or the light-source field of view may be larger than the receiver field of view. As an example, Θ_{L} may be approximately equal to 3 mrad, and Θ_{R} may be approximately equal to 4 mrad. As another example, OR may be approximately L times larger than Θ_{L}, where L is any suitable factor, such as for example, 1.1, 1.2, 1.5, 2, 3, 5, or 10.

In particular embodiments, a pixel 210 may represent or may correspond to a light-source field of view or a receiver field of view. As the output beam 125 propagates from the light source 110, the diameter of the output beam 125 (as well as the size of the corresponding pixel 210) may increase according to the beam divergence Θ_{L}. As an example, if the output beam 125 has a Θ_{L} of 2 mrad, then at a distance of 100 m from the lidar system 100, the output beam 125 may have a size or diameter of approximately 20 cm, and a corresponding pixel 210 may also have a corresponding size or diameter of approximately 20 cm. At a distance of 200 m from the lidar system 100, the output beam 125 and the corresponding pixel 210 may each have a diameter of approximately 40 cm.

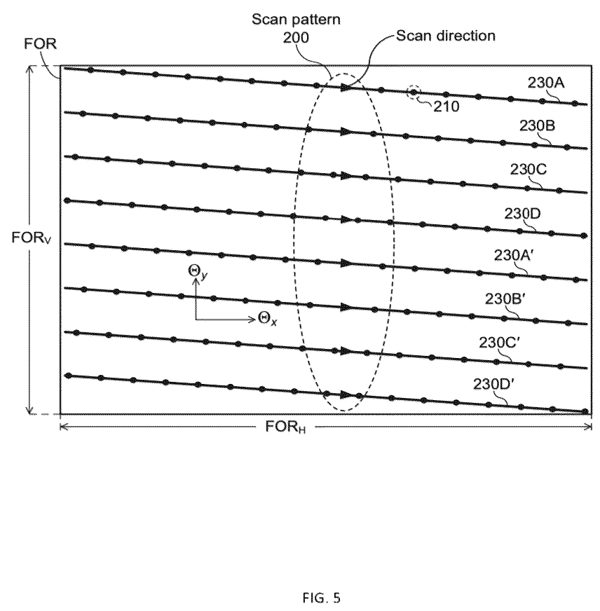

FIG. 5 illustrates an example unidirectional scan pattern 200 that includes multiple pixels 210 and multiple scan lines 230. In particular embodiments, scan pattern 200 may include any suitable number of scan lines 230 (e.g., approximately 1, 2, 5, 10, 20, 50, 100, 500, or 1,000 scan lines), and each scan line 230 of a scan pattern 200 may include any suitable number of pixels 210 (e.g., 1, 2, 5, 10, 20, 50, 100, 200, 500, 1,000, 2,000, or 5,000 pixels). The scan pattern 200 illustrated in FIG. 5 includes eight scan lines 230, and each scan line 230 includes approximately 16 pixels 210. In particular embodiments, a scan pattern 200 where the scan lines 230 are scanned in two directions (e.g., alternately scanning from right to left and then from left to right) may be referred to as a bidirectional scan pattern 200, and a scan pattern 200 where the scan lines 230 are scanned in the same direction may be referred to as a unidirectional scan pattern 200. The scan pattern 200 in FIG. 2 may be referred to as a bidirectional scan pattern, and the scan pattern 200 in FIG. 5 may be referred to as a unidirectional scan pattern 200 where each scan line 230 travels across the FOR in substantially the same direction (e.g., approximately from left to right as viewed from the lidar system 100). In particular embodiments, scan lines 230 of a unidirectional scan pattern 200 may be directed across a FOR in any suitable direction, such as for example, from left to right, from right to left, from top to bottom, from bottom to top, or at any suitable angle (e.g., at a 0°, 5°, 10°, 30°, or 45° angle) with respect to a horizontal or vertical axis. In particular embodiments, each scan line 230 in a unidirectional scan pattern 200 may be a separate line that is not directly connected to a previous or subsequent scan line 230.

In particular embodiments, a unidirectional scan pattern 200 may be produced by a scanner 120 that includes a polygon mirror (e.g., polygon mirror 301 of FIG. 3), where each scan line 230 is associated with a particular reflective surface 320 of the polygon mirror. As an example, reflective surface 320A of polygon mirror 301 in FIG. 3 may produce scan line 230A in FIG. 5. Similarly, as the polygon mirror 301 rotates, reflective surfaces 320B, 320C, and 320D may successively produce scan lines 230B, 230C, and 230D, respectively. Additionally, for a subsequent revolution of the polygon mirror 301, the scan lines 230A′, 230B′, 230C′, and 230D′ may be successively produced by reflections of the output beam 125 from reflective surfaces 320A, 320B, 320C, and 320D, respectively. In particular embodiments, N successive scan lines 230 of a unidirectional scan pattern 200 may correspond to one full revolution of an N-sided polygon mirror. As an example, the four scan lines 230A, 230B, 230C, and 230D in FIG. 5 may correspond to one full revolution of the four-sided polygon mirror 301 in FIG. 3. Additionally, a subsequent revolution of the polygon mirror 301 may produce the next four scan lines 230A′, 230B′, 230C′, and 230D′ in FIG. 5.

Blockage detection is an important feature in an automotive LIDAR. The impact of an obscurant located on the outer optical interface (henceforth referred to as the window) is multifold, as photons that are destined to travel outwards and sample the environment may be redirected and/or extinguished by the obscurant. As a result, these photons may return prematurely and get captured by the receiver/detector, causing false alarms of detecting objects in the immediate proximity of the vehicle. These photons may be deflected away from their intended direction, resulting in loss of visibility along the respective direction (or ray), which may result in either losing a target altogether, or producing low reflectance estimates in the targets that are still detected. These photons may be absorbed in the obscurant material, which also causes a loss of visibility. Therefore, obscurants on the lidar window may have a profound detrimental effect on the quality of the point cloud, including a drastic decrease in visibility.

The present application discloses improved techniques for detecting absorbing obscurants, such as rain droplets, which scatter a minimal amount of photons. The improved techniques include two detection metrics, one based on the backscattered energy, and one based on the range to the detected obscurant. Together, they are employed to increase detection confidence and eliminate false alarms, such as strong reflectors a few meters away, or photons reflected by a clean window. The localization accuracy is also high due to mechanisms that compensate for optical artifacts, such as azimuth lag. The improved techniques provide information to determine if the obscurant is placed on the window or in close proximity.

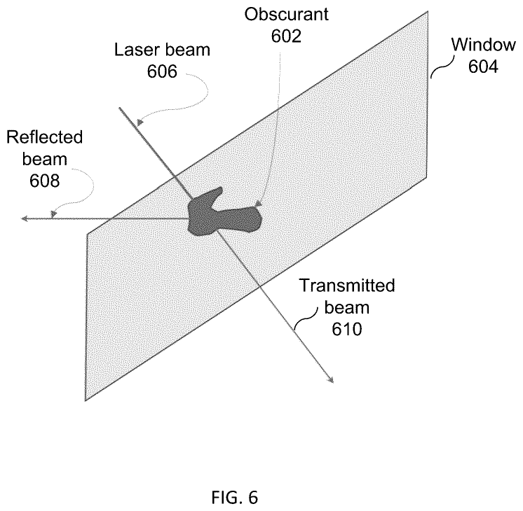

FIG. 6 illustrates an example of an obscurant located on the window causing a portion of a laser beam to be reflected by the obscurant or absorbed by the obscurant material. As shown in FIG. 6, a patch of obscurant 602 is located on a window 604. When a laser beam 606 hits obscurant 602 on window 604, a portion of laser beam 606 is reflected as a reflected beam 608. A portion of laser beam 606 is absorbed by obscurant 602. And a portion of laser beam 606 is transmitted through obscurant 602 and window 604 as a transmitted beam 610.

Absorption is particularly concerning because the detection of this phenomenon is difficult. Photons that are absorbed in the obscurant material will heat the respective material, instead of returning to the detector where they can be captured. Examples of opaque obscurants on the window may include bird droppings, bug splats, mud drops, and even physical damage (cracks, chips) on the window caused by pebbles. Examples of opaque obscurants that are located in the immediate proximity of the lidar system include obscurants that are in front of the window, such as exhaust smoke, dust, and road spray. Examples of transparent obscurants are rain and mist drops, fog particles, or a foggy window. In practice, most obscurants will exhibit both absorption and scattering in different proportions given by the nature of the material they are made of.

To further complicate blockage detection, in a scanned LIDAR system, the outgoing photons and the incoming photons produced by returns from the outgoing ones may cross the optical interface (the system window) at different spatial locations, called the transmit aperture and the receive aperture, respectively. These apertures may intersect, but are typically not identical, especially in a scanned LIDAR. An obscurant may be located within the receive aperture, but not the transmit aperture. It is therefore important that the blockage detection, which utilizes only the transmit aperture, be aware of the regions where the receive aperture does not intersect with the transmit aperture. More specifically, if there are regions on the window that are only crossed by incoming photons and not outgoing photons, the scan patterns must be extended to cover these regions for the purpose of blockage detection. These areas are referred to as over-scanning areas.

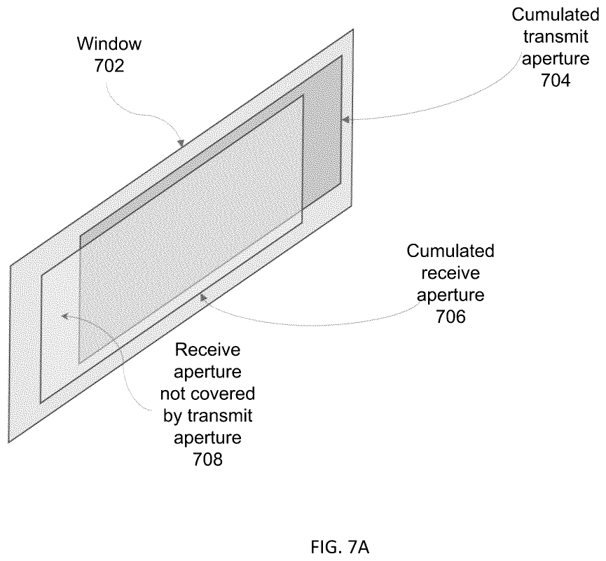

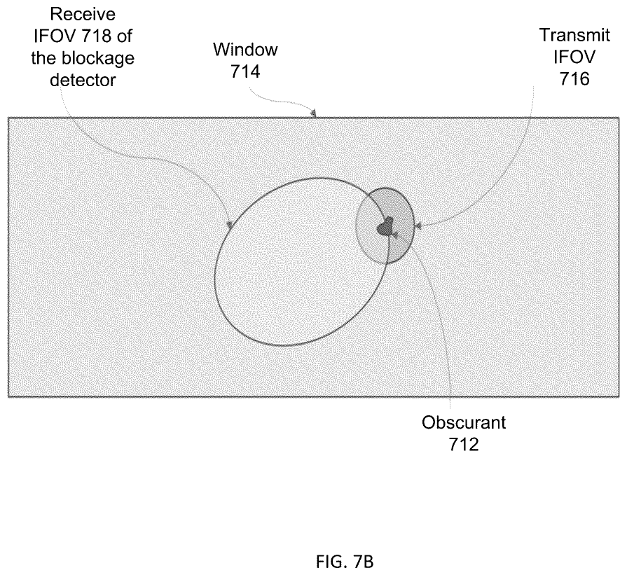

FIG. 7A illustrates an example of a hypothetical geometry showing the cumulated transmit aperture and the cumulated receive aperture of a main detector over the entire scan. The cumulated transmit aperture 704 shows the geometric locus of the intersections of the totality of rays transmitted by the system with a window 702. In particular, multiple rays are sent through window 702. The transmit field of view (FOV) refers to the angular extent over which the lidar system can send out its laser beams. It is the total area that the emitted laser rays cover as they pass through the transmit aperture and into the environment. The cumulated receive aperture 706 represents the geometric locus of the totality of incoming photons of the returns from targets in the scene. As shown in FIG. 7A, cumulated transmit aperture 704 and cumulated receive aperture 706 do not overlap completely. The non-overlapping area 708 (also referred to as the over-scanning area 708) is the area in the cumulated receive aperture 706 that is not covered by cumulated transmit aperture 704.

If a blockage is located within cumulated transmit aperture 704, then the blockage can be detected because the outgoing rays will hit the blockage, and photons will be scattered and detected by the detector. However, if a blockage is located within the non-overlapping area 708, then the blockage cannot be detected properly because the outgoing rays will not hit the blockage and thus photons cannot be scattered and detected by the detector. Therefore, additional over-scanning rays are transmitted through the over-scanning area 708 (the area in the cumulated receive aperture 706 that is not covered by cumulated transmit aperture 704) for blockage detection purposes. These over-scanning rays are not expected to produce returns from the scene and will be monitored just for returns from very close ranges.

FIG. 7B illustrates a system with a single ray, in which the receive instantaneous field of view (IFOV) of the blockage detector is not completely overlapping with the transmit IFOV of the system. An obscurant 712 is located on a window 714. For obscurant 712 to be detected, obscurant 712 needs to be located in the intersection between the receive IFOV 718 of the blockage detector and the transmit IFOV 716 of the sensor.

Since transmit IFOV 716 and receive IFOV 718 do not overlap completely, and furthermore, their overlap varies with the azimuth and elevation (or equivalently, their overlap varies with the position of the ray cross-section on the window), the blockage detector is configured to compensate for the difference.

Referring back to FIG. 7A, additional over-scanning rays are transmitted through the over-scanning area 708 (the area in the cumulated receive aperture 706 that is not covered by cumulated transmit aperture 704) for blockage detection purposes. This is referred to as over-scanning because rays are scanned through additional areas that are normally not required to be scanned in order to determine the point cloud or the three-dimensional image of the environment. In some embodiments, over-scanning may be performed for every frame. For example, the transmit aperture is expanded by scanning window 702 from left to right and from top to bottom to cover the over-scanning area 708 as well.

The over-scanning rays are not expected to produce returns from the scene and will be monitored just for returns from very close ranges. In some embodiments, returns of the over-scanning rays from the scene and at certain angular coordinates are not recorded, and only returns of the over-scanning rays from very close ranges are monitored. For example, signals corresponding to the returns of the over-scanning rays from the scene received by the main detector that is used to detect any downstream targets are not recorded, while signals corresponding to returns of the over-scanning rays from very close ranges received by the blockage detector for nearfield obscurants or the blockage detector for obscurants on the window are monitored for blockage detection. The advantage is that the amount of data that is captured is significantly reduced, thereby saving a significant amount of storage or memory.

The blockage detector disclosed in the present application includes a number of characteristics and advantages. In some embodiments, the blockage detector has a high sensitivity in order to detect low-scatter obscurants that may, nevertheless, have significant impact on the quality of the point cloud through photon absorption. Examples of low-scatter obscurants include clean rain droplets. In some embodiments, the blockage detector has a high selectivity in order to ensure that the inherent reflectance of the outer window is not going to be reported as blockage. In some embodiments, the blockage detector has a high spatial accuracy, in the sense that it can precisely identify the ray that is blocked. In some embodiments, the blockage detector has the ability to over-scan in order to cover the areas on the window, where the cumulated receive aperture of the main detector is not intersecting the cumulated transmit aperture. In some embodiments, the blockage detector has the ability to compensate for the variable lag incurred because of the relative geometries of the receive IFOV of the blockage detector and the transmit IFOV of the system (blockage lag). In some embodiments, the blockage detector has the ability to discriminate obscurants that are located on the window from obscurants that are present in the nearfield or in front of the window, and label them accordingly. This capability is important because it may be used to trigger a cleaning operation on the window. In some embodiments, the blockage detector has the ability to provide a blockage severity scale. In some embodiments, the severity scale is defined to have a range between 1 (minimum blockage) and 10 (maximum severity). In practice, the sensitive detectors employed in the circuit may saturate before a physical blockage level of 100% has been reached. For clarity, the physical blockage level is defined as the percentage of photons that are effectively blocked or absorbed by the obscurant. In this case, the maximum severity level of 10 will be placed at the energy saturation level of the hardware.

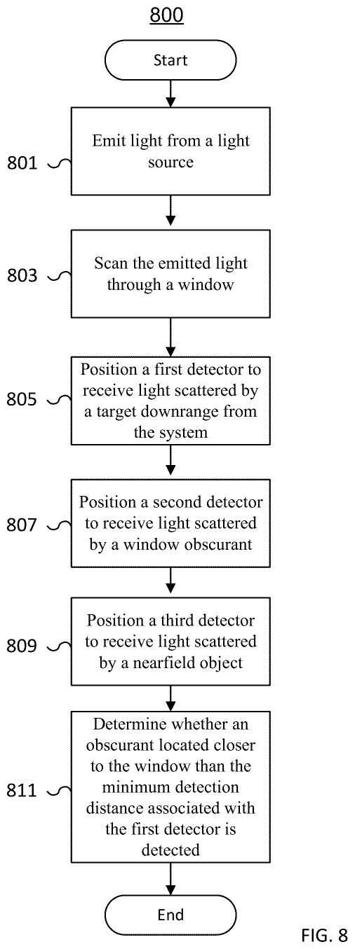

FIG. 8 is a flow chart illustrating an embodiment of a process 800 of a lidar system for window blockage or nearfield object detection. In some embodiments, the lidar system performing the process of FIG. 8 is lidar system 100 of FIGS. 1-4.

At 801, light is emitted from a light source. For example, light is emitted from light source 110 of lidar system 100 of FIGS. 1 and 3. Light source 110 may include a pulsed or CW laser.

At 803, the emitted light is scanned through a window at a first range of azimuth angles and a first range of elevation angles. For example, the emitted light is scanned through sensor window 157 of lidar system 100 of FIGS. 1 and 3. For example, the azimuth angle coordinates may range from negative 60 degrees to plus 60 degrees. The elevation angles for the outgoing rays may range from negative 10 to plus 5 degrees. The cumulated transmit aperture 704 in FIG. 7A shows one example of the geometric locus of the intersections of the totality of rays transmitted by the system with a window 702.

At steps 805, 807, and 809, three different types of detectors are positioned to receive the emitted light scattered by different types of targets or objects. At 805, a first detector is positioned to receive at least a portion of the emitted light scattered by a target located downrange from the system. At 807, a second detector is positioned to receive at least a portion of the emitted light scattered by a window obscurant on the window. At 809, a third detector is positioned to receive at least a portion of the emitted light scattered by a close obscurant located within a distance range that is between a minimum detection distance associated with the first detector and a maximum detection distance associated with the second detector.

In a long-distance automotive LIDAR, the optical system is designed for long-range focus. More specifically, photons that arrive from long range targets form a small and intense spot that is positioned on top of the active area of the main detector(s). In contrast, photons that arrive from close proximity, such as the ones reflected or scattered by obscurants on the window of the system, will form a large and dim spot that will be positioned away from the active areas of the detector(s).

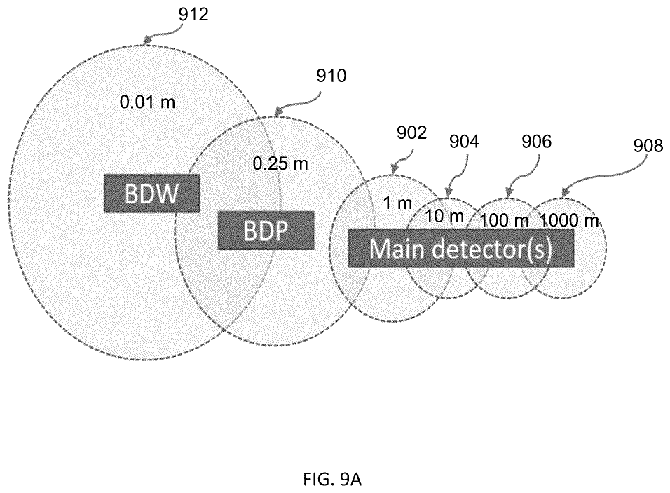

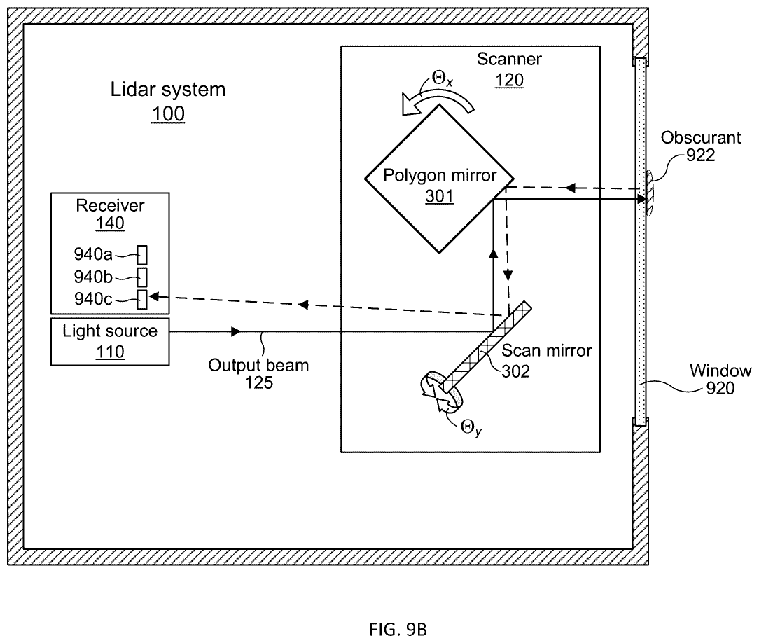

FIG. 9A shows an example of a possible distribution of detectors and return projections on the detector plane. The circular shapes represent the 1/e² spot sizes and locations of returns that arrive from targets at the specified ranges away from the system. Locations 902, 904, 906, and 908 correspond to the 1 meter, 10 meter, 100 meter, and 1000 meter target ranges, respectively. The main detector is designed to capture returns from regular targets in these target ranges in the scene that will be aggregated to create the point cloud. Location 910 corresponds to the 0.25 meter target range. For these targets in close proximity, a new detector, labeled as BDP (blockage detector for proximity obscurants) is used. BDP may also be referred to as BDN (blockage detector for nearfield obscurants). Location 912 corresponds to the 0.01 meter target range. For these obscurants located on the window, another detector labeled as BDW (blockage detector for obscurants on the window) is used. In some embodiments, BDW is configured to be a more sensitive detector than BDP or the main detector, in order to capture faint returns from obscurants that are primarily absorbers.

FIG. 9B illustrates an example lidar system 100 with an example obscurant 922 on a sensor window 920. FIG. 9B shows scattered light from obscurant 922 that is incident on detector 940c. Detector 940a represents the main detector(s) (one or more detectors for detecting scattered light from targets located >0.5-300 meters from lidar system 100). Detector 940b is the BDP (proximity detector), and detector 940c is the BDW (detector for obscurants on the window). The continuous rotation of the polygon mirror causes received light to “sweep” across the detectors so that light scattered from nearby objects (e.g., <0.2 m) will primarily be incident on detector 940c, and light scattered from distant objects (e.g., 1-300 m away) will primarily be incident on detector 940a.

In FIG. 9B, the light is shown as a single ray, but the light is typically distributed along the transverse direction, which means some of the scattered light will likely also be incident on detector 940b. In some embodiments, window 920 may be a window that is part of the lidar system enclosure. In some other embodiments, lidar system 100 is installed behind the windshield of a car, and window 920 may represent the car windshield.

Referring back to FIG. 8 again, at 811, it is determined whether an obscurant located closer to the window than the minimum detection distance associated with the first detector is detected. In some embodiments, it is determined whether an obscurant located closer to the window than the minimum detection distance associated with the first detector is detected based on one or more signal properties of the second detector (BDW) and one or more signal properties of the third detector (BDN).

In some embodiments, the one or more signal properties of the second detector comprise a range metric of the second detector and an energy metric of the second detector, and the one or more signal properties of the third detector comprise a range metric of the third detector and an energy metric of the third detector.

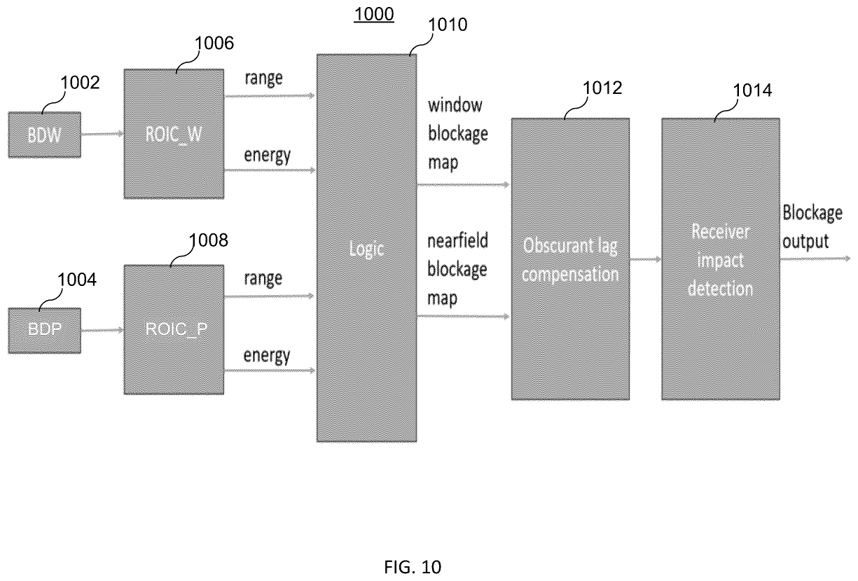

In some embodiments, each of the blockage detectors may produce two metrics that may be employed to detect, characterize, and assess the severity of the obscurant. FIG. 10 illustrates an exemplary system 1000 for detecting different types of blockage. System 1000 produces two types of metrics that may be employed to detect, characterize, and assess the severity of the obscurant. These two metrics are: 1) the range of the return produced by the obscurant, and 2) the energy in this return. BDW detector 1002 is connected to a read-out circuit (ROIC) referred to as ROIC_W 1006. BDP detector 1004 is connected to an ROIC referred to as ROIC_P 1008. ROIC_W 1006 and ROIC_P 1008 each provides range and energy metrics to a logic module 1010. Logic module 1010 provides a window blockage map and a nearfield blockage map to an obscurant lag compensation module 1012. System 1000 further includes a receiver impact detection module 1014 that provides a blockage output.

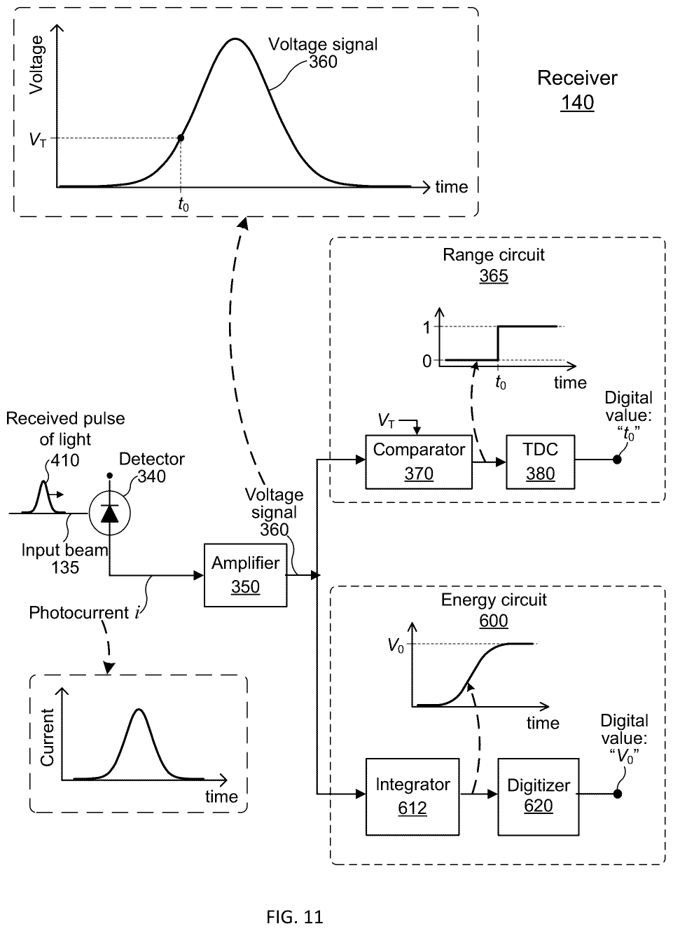

In some embodiments, the range information is produced by comparator circuits in the ROICs, and the energy information is produced by analog integrator circuits in the ROICs. FIG. 11 shows the various electronic signals produced by the detector circuitry. FIG. 11 illustrates an example receiver 140 and an example voltage signal 360 corresponding to a received pulse of light 410. A light source 110 of a lidar system 100 may emit a pulse of light, and a receiver 140 may be configured to detect an input beam 135 that includes a received pulse of light 410. In particular embodiments, a receiver 140 of a lidar system 100 may include one or more detectors 340, one or more amplifiers 350, one or more range circuits 365, and one or more energy circuits 600. A range circuit 365 may include a comparator 370 and a time-to-digital converter (TDC) 380.

The receiver 140 illustrated in FIG. 11 includes a detector 340 configured to receive input beam 135 and produce a photocurrent i that corresponds to a received pulse of light 410 (which is part of the input beam 135). The photocurrent i produced by the detector 340 may be referred to as a photocurrent signal or an electrical-current signal. The detector 340 may include an APD, PN photodiode, or PIN photodiode. For example, the detector 340 may include a silicon APD or PIN photodiode configured to detect light at an 800-1100 nm operating wavelength of a lidar system 100, or the detector 340 may include an InGaAs APD or PIN photodiode configured to detect light at a 1200-1600 nm operating wavelength. In FIG. 11, the detector 340 is coupled to an electronic amplifier 350 configured to receive the photocurrent i and produce a voltage signal 360 that corresponds to the received photocurrent. For example, the detector 340 may be an APD that produces a pulse of photocurrent in response to detecting a received pulse of light 410, and the voltage signal 360 may be an analog voltage pulse that corresponds to the pulse of a photocurrent. The amplifier 350 may include a transimpedance amplifier configured to receive the photocurrent i and amplify the photocurrent to produce a voltage signal that corresponds to the photocurrent signal. Additionally, the amplifier 350 may include a voltage amplifier that amplifies the voltage signal or an electronic filter (e.g., a low-pass or high-pass filter) that filters the photocurrent or the voltage signal.

In FIG. 11, the voltage signal 360 produced by the amplifier 350 is coupled to a range circuit 365. The range circuit includes a comparator 370, and comparator 370 is supplied with a particular threshold or reference voltage (V_{T}). Comparator 370 may produce an electrical-edge signal (e.g., a rising or falling electrical edge) when the voltage signal 360 rises above or falls below a particular threshold voltage. For example, comparator 370 may produce a rising edge when the voltage signal 360 rises above the threshold voltage V_{T}. Additionally or alternatively, comparator 370 may produce a falling edge when the voltage signal 360 falls below the threshold voltage V_{T}.

The range circuit 365 in FIG. 11 includes a time-to-digital converter (TDC) 380, and comparator 370 is coupled to TDC 380. A comparator-TDC pair in FIG. 11 may be referred to as a threshold detector. A comparator may provide an electrical-edge signal to a corresponding TDC, and the TDC may act as a timer that produces an electrical output signal (e.g., a digital signal, a digital word, or a digital value) that represents a time when the edge signal is received from the comparator. For example, if the voltage signal 360 rises above the threshold voltage V_{T}, then comparator 370 may produce a rising-edge signal that is supplied to the input of TDC 380, and TDC 380 may produce a digital time value (t₀) corresponding to a time when the edge signal was received by TDC 380. The digital time value may be referenced to the time when a pulse of light is emitted, and the digital time value may correspond to or may be used to determine a round-trip time for the pulse of light to travel to a target 130 and back to the lidar system 100. Additionally, if the voltage signal 360 subsequently falls below the threshold voltage V_{T}, then comparator 370 may produce a falling-edge signal that is supplied to the input of TDC 380, and TDC 380 may produce a digital time value corresponding to a time when the edge signal was received by TDC 380. The output of range circuit 365 may be sent to a controller 150, and a time-of-arrival for the received pulse of light 410 may be determined based at least in part on the one or more time values produced by TDC 380. The output of range circuit 365 in FIG. 11 may be a portion of the electrical output signal 145 in FIG. 1.

In particular embodiments, the output of range circuit 365 may include one or more digital values that correspond to a time interval between (1) a time when a pulse of light is emitted and (2) a time when a received pulse of light 410 is detected by a receiver 140. The output signal of range circuit 365 in FIG. 11 may include digital values from TDC 380 that receives edge signals from comparator 370, and each digital value may represent a time interval between the emission of an optical pulse by a light source 110 and the receipt of an edge signal from comparator 370. For example, a light source 110 may emit a pulse of light that is scattered by a target 130, and a receiver 140 may receive a portion of the scattered pulse of light as an input pulse of light 410. When the light source emits the pulse of light, a count value of TDC 380 may be reset to a zero count. Alternatively, TDC 380 in receiver 140 may accumulate the counts continuously over multiple pulse periods (e.g., for 10, 100, 1,000, 10,000, or 100,000 pulse periods), and when a pulse of light is emitted, the current TDC count may be stored in memory. After the pulse of light is emitted, TDC 380 may continue to accumulate counts that correspond to elapsed time (e.g., TDC 380 may count in terms of clock cycles or some fraction of clock cycles).

In FIG. 11, when TDC 380 receives an edge signal from comparator 370, TDC 380 may produce a digital signal that represents the time interval between emission of the pulse of light and receipt of the edge signal. For example, the digital signal may include a digital value that corresponds to the number of clock cycles that elapsed between emission of the pulse of light and receipt of the edge signal. Alternatively, if TDC 380 accumulates counts over multiple pulse periods, then the digital signal may include a digital value that corresponds to the TDC count at the time of receipt of the edge signal. The output signal of range circuit 365 may include digital values corresponding to one or more times when a pulse of light was emitted and one or more times when TDC 380 received an edge signal. The output signal of range circuit 365 may be sent to a controller 150, and the controller may determine the distance (i.e., a range metric) to a target, an obscurant on the window, or a nearfield object based at least in part on the output signal of range circuit 365.

In FIG. 11, the voltage signal 360 produced by the amplifier 350 is also coupled to an energy circuit 600. Energy information is produced by energy circuit 600. Energy circuit 600 includes an integrator 612. Energy circuit 600 in FIG. 11 includes a digitizer 620, and integrator 612 is coupled to digitizer 620. Integrator 612 may provide an electrical signal to digitizer 620, and digitizer 620 may produce an electrical output signal V₀ (e.g., a digital signal, a digital word, or a digital value) corresponding to the received pulse of light 410. The output of energy circuit 600 in FIG. 11 may be a portion of the electrical output signal 145 in FIG. 1. The output signal of energy circuit 600 may be sent to a controller 150, and the controller may determine an energy metric corresponding to the received pulse of light 410.

In some embodiments, the techniques presented in the present application may be performed by logic module 1010 in FIG. 10. The present application discloses techniques to calibrate the BDW ROICs and the BDP ROICs to respond to the prespecified obscurant characteristics, such as the reflectance range and minimum size of the obscurants that must be detected.

Both the range metrics and the energy metrics may be calibrated. In some embodiments, both ROICs include an analog amplifier with gains that are adequate for the signal produced by obscurants. The amplifier is configured to detect the minimum obscurant (in size and reflectance) specified by the requirements.

In some embodiments, the energy metrics may be calibrated. In some embodiments, the energy of the obscurant returns is generated by an analog integrator (e.g., integrator 612 in FIG. 11), which is controlled by two timing settings. In some embodiments, the timing settings may be used to control the start and the stop of the integration process and may be determined based on experiments. The start signal is based on the known time interval between the trigger of the laser pulse and the moment at which the pulse crosses the window. Slight variations in timing between the window crossing moment through the center of the window and the window crossing moment through a corner of the window have been found to be negligible. In some embodiments, the stop signal may be determined experimentally. The integration process may be stopped when the integrator energy readout has reached a detectable level for the obscurants of the minimum size and reflectance stipulated by requirements.

In some embodiments, the range metrics may be calibrated. In some embodiments, the range information is generated by a comparator circuit (e.g., range circuit 365 of FIG. 11) that compares the blockage detector (BDW or BDN) signal against a predetermined threshold (e.g., V_{T} in FIG. 11). This predetermined threshold may be calibrated. The predetermined threshold (V_{T}) may be chosen to be low enough to ensure a good sensitivity, but high enough to bypass the inherent noise floor. The actual value for the predetermined comparator threshold (V_{T}) may be chosen experimentally.

Since the range and energy estimates are independent, they may be employed separately or in combination to form a multitude of detection criteria. In some embodiments, these criteria are applied successively, either to increase confidence in the blockage detection process or, in other situations, to recover obscurants that have been missed by earlier criteria.

In some embodiments, one criterion is that the range to the obscurant is situated within a certain interval. The range to the obscurant is below a predetermined threshold. This criterion may be used to reject certain targets, mostly retroreflectors, that are further away than the maximum distance stipulated for blockage detection but are detected by the blockage detectors because they are very strong, such as retroreflectors.

To compensate for possible drifts with temperature, or other factors, the detection criteria above may be parameterized and include parameters that may be compensated for the respective drifts. For example, if the laser is known to exhibit timing drifts with temperature, then the range interval employed in the criterion listed above may be expressed as a [T0+Start, T0+Stop], where T0 is a parameter that is temperature compensated.

In some embodiments, one criterion is that the energy of the obscurant return is higher than a certain predetermined threshold. The energy interval between this minimum predetermined threshold and the energy level where the energy information saturates may be divided into 10, or a different number of blockage severity levels. The minimum threshold may be employed to ensure that a clean window will not be falsely detected as having an obscurant.

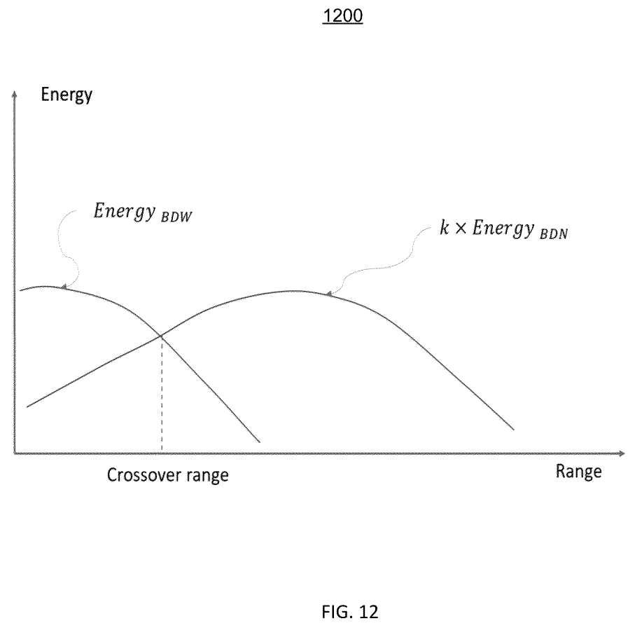

FIG. 12 shows an example chart 1200 for calibrating an energy comparison criterion. In some embodiments, one criterion of detecting an obscurant on the window is that the energy in the BDW is higher than the energy in the BDN. In some embodiments, a criterion of detecting a nearfield object includes a weight (k) for scaling the energy in the BDN as shown in equation 1 below:

Energy_{BDW}<k*Energy_{BDN} (1)

The criterion is employed as a discriminator between window obscurants and nearfield obscurants. The coefficient k may be used to calibrate the crossover range between what is called obscurant on the window and obscurant in the nearfield. In some embodiments, all the obscurants that are situated up to 10-20 cm in front of the system may be identified as “obscurants on the window.”

In some embodiments, the default value of k is 1. However, the 10-20 cm crossover range may be adjustable by varying k. For example, by adjusting k, the curve (k*Energy_{BDN}) may be elevated, and the crossover range may be adjusted to a smaller distance from the window. Similarly, by adjusting k, the curve (k*Energy_{BDN}) may be lowered, and the crossover range may be adjusted to a greater distance from the window.

In some embodiments, the crossover range may be configured to a smaller distance (e.g., 1 cm), such that the detection of an obscurant on the window may be used to further trigger a process on the system to clean the window.

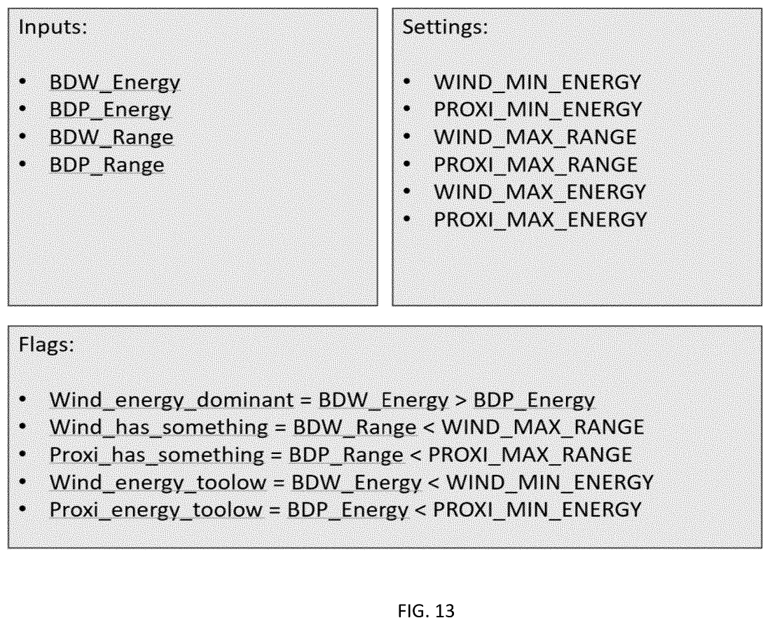

With reference to FIG. 10 again, logic module 1010 is executed for every transmitted ray. FIG. 13 illustrates the examples of inputs, settings, and flags for calibrating logic module 1010. Logic module 1010 employs the energy and range data input from each of the blockage detectors, BDW detector 1002 and BDP detector 1004. As shown in FIG. 13, the inputs include the energy input BDW_Energy from ROIC_W 1006, the energy input BDP_Energy from ROIC_P 1008, the range input BDW_Range from ROIC_W 1006, and the range input BDP_Range from ROIC_P 1008.

In addition, a few settings/parameters may be used for calibration. The settings include a minimum energy threshold WIND_MIN_ENERGY, a minimum energy threshold PROXI_MIN_ENERGY, a maximum range threshold WIND_MAX_RANGE, a maximum range threshold PROXI_MAX_RANGE, a maximum energy threshold WIND_MAX_ENERGY, and a maximum energy threshold PROXI_MAX_ENERGY.

In addition, a few flags may be used for calibration. The flag Wind_energy_dominant is set to true if the energy in BDW (BDW_Energy) is higher than the energy in BDP (BDP_Energy).

The flag Wind_has_something is set to true if the BDW comparator does detect blockage and issues a range (BDW_Range) to the said blockage that is within the admissible interval (WIND_MAX_RANGE).

The flag Wind_energy_toolow is set to true if BDW detects a returned energy (BDW_Energy) that is below a predefined threshold (WIND_MIN_ENERGY).

The flag Proxi_has_something is set to true if the BDP comparator does detect blockage and issues a range (BDP_Range) to the said blockage that is within the admissible interval (PROXI_MAX_RANGE).

The flag Proxi_energy_toolow is set to true if BDP detects a returned energy (BDP_Energy) that is below a predefined threshold (PROXI_MIN_ENERGY).

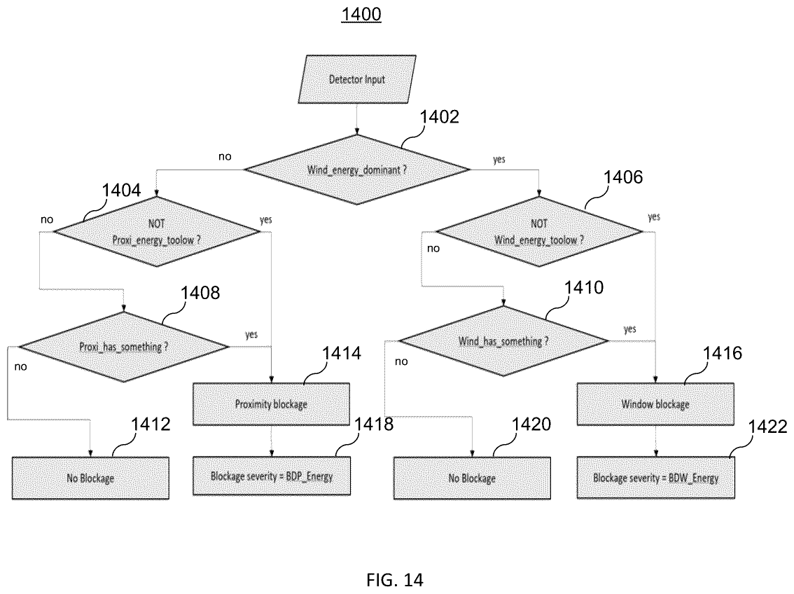

FIG. 14 illustrates an exemplary process 1400 that may be performed by logic module 1010. Logic module 1010 first determines which of the energy readings of the BDW and of the BDP is higher. If the BDW energy is higher, it is then compared with a predefined admissibility threshold in order to avoid returns from a clean window, which will still backscatter photons. If the energy is too low, there is still a possibility that a weak scatterer is present on the window, which will be detected in the comparator-issued range for the respective ray. This mechanism is designed to detect clean droplets of water on the window. The same steps are duplicated for the proximity detector BDP.

At step 1402, it is determined whether the energy reading of the BDW is higher than the energy reading in the BDP. The flag Wind_energy_dominant is set to true if the energy in BDW (BDW_Energy) is higher than the energy in BDP (BDP_Energy). If BDW's energy reading is higher than BDP's energy reading, then the flag Wind_energy_dominant is true, and process 1400 proceeds to step 1406; otherwise, Wind_energy_dominant is false, and process 1400 proceeds to step 1404.

At step 1406, it is determined whether BDW's energy reading is not below a predefined threshold. The flag Wind_energy_toolow is set to true if BDW detects a returned energy (BDW_Energy) that is below a predefined threshold (WIND_MIN_ENERGY). If BDW's reading of the returned energy is not below the predefined threshold, then Wind_energy_toolow=false, and process 1400 proceeds to step 1416 and step 1422. At step 1416, a window blockage is determined. At step 1422, the blockage severity level is determined. The blockage severity level may be determined based on the energy detected by BDW, i.e., BDW_Energy. For example, the blockage severity level may be set to BDW_Energy. If BDW's reading of the returned energy is below the predefined threshold, then Wind_energy_toolow=true, and process 1400 proceeds to step 1410.

At step 1410, it is determined whether the BDW comparator does detect blockage and issues a range (BDW_Range) to the said blockage that is within the admissible interval (WIND_MAX_RANGE). If yes, then Wind_has_something=true, and process 1400 proceeds to step 1416 and step 1422. At step 1416, a window blockage is determined. At step 1422, the blockage severity level is determined. The blockage severity level may be determined based on the energy detected by BDW, i.e., BDW_Energy. For example, the blockage severity level may be set to BDW_Energy. If Wind_has_something=false, then process 1400 proceeds to step 1420 in which no blockage is detected.

At step 1404, it is determined whether BDP's energy reading is not below a predefined threshold. If BDP's reading of the returned energy is not below the predefined threshold, then Proxi_energy_toolow=false, and process 1400 proceeds to step 1414 and step 1418, wherein step 1414 determines that there is a proximity blockage and wherein step 1418 determines the blockage severity level and sets it to the energy detected by BDP, i.e., BDP_Energy. If BDP's reading of the returned energy is below the predefined threshold, then Proxi_energy_toolow=true, and process 1400 proceeds to step 1408.

At step 1408, it is determined whether the BDP comparator does detect blockage and issues a range to the said blockage that is within the admissible interval (PROXI_MIN_RANGE). If yes, then Proxi_has_something=true, and process 1400 proceeds to step 1414 and step 1418, wherein step 1414 determines that there is a proximity blockage and wherein step 1418 determines the blockage severity level and sets it to the energy detected by BDP, i.e., BDP_Energy. If Proxi_has_something=false, then process 1400 proceeds to step 1412 in which no blockage is detected.

As shown in FIG. 14, process 1400 has three possible detected outcomes: no blockage, window blockage, or proximity blockage. However, it should be recognized that a simpler process may use a single blockage detector and waive the benefit of window vs proximity discrimination, but still be able to detect when the outgoing rays would encounter obscurants, etc.

Referring back to FIG. 10, logic module 1010 provides a window blockage map and a nearfield blockage map as outputs.

A window blockage map or a nearfield blockage map is a two-dimensional intensity map with each point along the x-axis and the y-axis representing a blockage severity level or blockage coefficient. A window blockage map is a two-dimensional map where each point represents the severity of blockage on a particular point of the window. A nearfield blockage map is a two-dimensional map where each point represents the severity of blockage on a particular point in a nearfield region (e.g., the area directly in front of the window). Both types of maps visually represent the degree of blockage across a defined area.

In some embodiments, the blockage severity level is defined to have a range between 1 (minimum blockage) and 10 (maximum severity). On a blockage map, each blockage severity level may be indicated by a different color. In some embodiments, each blockage severity level is indicated by a grayscale, which includes a range of shades of gray, from white (minimum blockage) to black (maximum blockage), with various shades of gray in between.

Along the x-axis of a blockage map includes a range of azimuth angles for the outgoing rays. For example, the azimuth angle coordinates may range from negative 60 degrees to plus 60 degrees. Along the y-axis of a blockage map includes a range of elevation angles for the outgoing rays. For example, the elevation angle may range from negative 10 to plus 5 degrees.

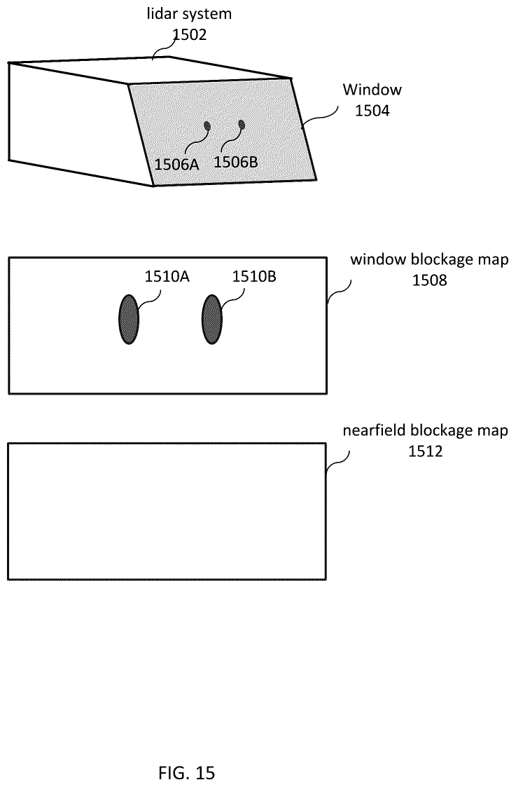

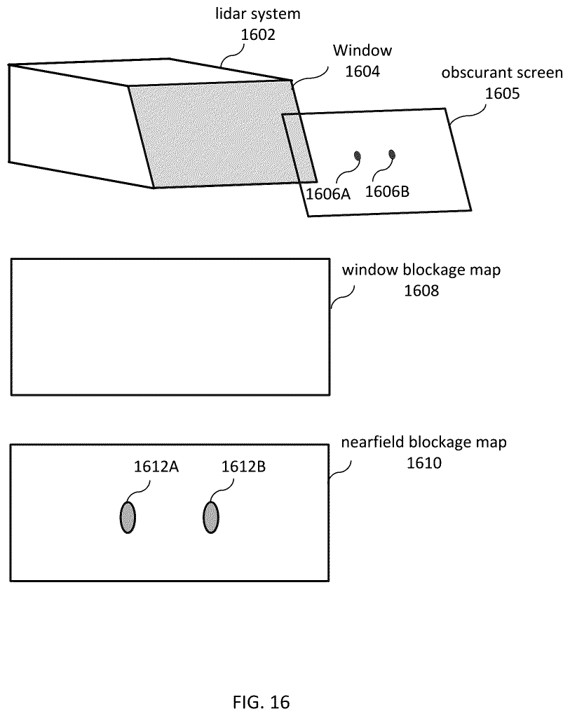

FIG. 15 illustrates an example of a window blockage map and an example of a nearfield blockage map when obscurants are located on the window. Lidar system 1502 includes a window 1504, and two obscurants (1506A and 1506B) are located on window 1504. Blockage detected region 1510A and blockage detected region 1510B on window blockage map 1508 correspond to obscurant 1506A and obscurant 1506B, respectively. These blockage detected regions on the window blockage map 1508 indicate the locations of the detected obscurants on window 1504. Nearfield blockage map 1512 does not include any blockage detected regions, indicating that no nearfield obscurants in front of window 1504 are detected. FIG. 16 illustrates an example of a window blockage map and an example of a nearfield blockage map when obscurants are located on an obscurant screen placed in front of the window. Lidar system 1602 includes a window 1604, and two obscurants (1606A and 1606B) are located on an obscurant screen 1605 placed in front of window 1604. Blockage detected region 1612A and blockage detected region 1612B on nearfield blockage map 1610 correspond to obscurant 1606A and obscurant 1606B, respectively. These blockage detected regions on the nearfield blockage map 1610 indicate the locations of the detected obscurants on obscurant screen 1605. Window blockage map 1608 does not include any blockage detected regions, indicating that no obscurants on window 1604 are detected. As shown in FIG. 15 and FIG. 16, obscurants of the same size and optical characteristics appear larger and more contrasting when placed on the window rather than in the nearfield.

Referring back to FIG. 10, in some embodiments, system 1000 includes an obscurant lag compensation module 1012. In some embodiments, the lag compensation may be based on a look-up-table (LUT) obtained either experimentally or through an optical model. In another embodiment, an analytical formula can predict this lag in (azimuth, elevation) coordinates, based on the location of the intersection of the beam with the window where the blockage resides.

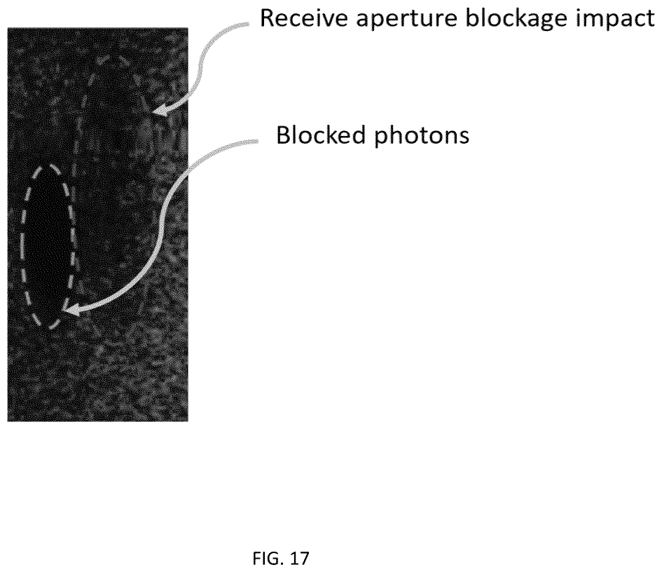

Referring to FIG. 10, in some embodiments, system 1000 includes a receiver impact detection module 1014. The receiver impact is a second order effect. Effectively, in scanned lidars, an obscurant placed on the window has the potential of blocking outgoing photons on the one hand, and incoming photons on the other. The incoming photons that are blocked by this obscurant may belong to rays that have left earlier and in a slightly different direction. Compensating for this impact may also be based on an LUT, but the respective LUT will have to be derived based on the range of the target that produced the reflection. FIG. 17 shows comparatively the impact that photons blocked at transmission (the left cluster) and reception (the right cluster) have on imaging a wall that is 5 meters away from the sensor. The reception impact is many times insignificant.

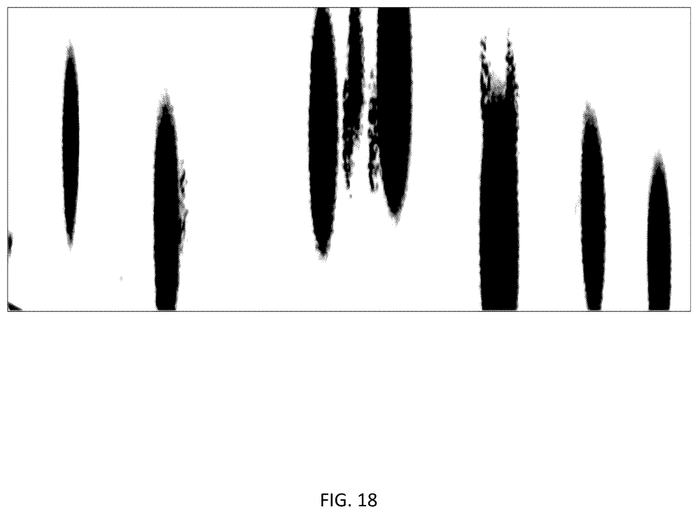

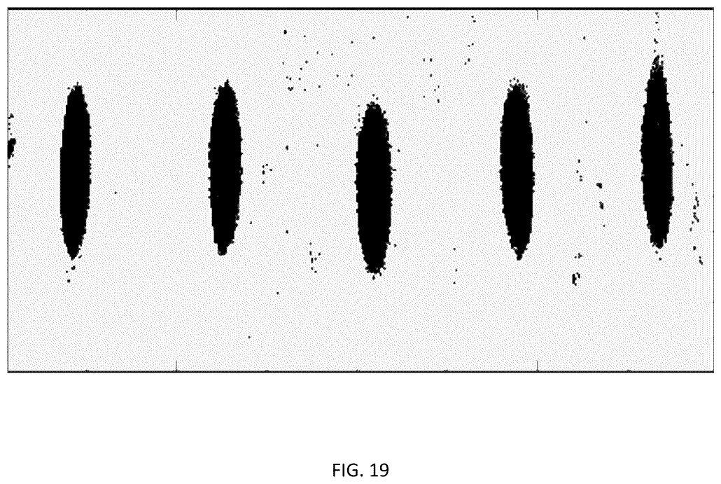

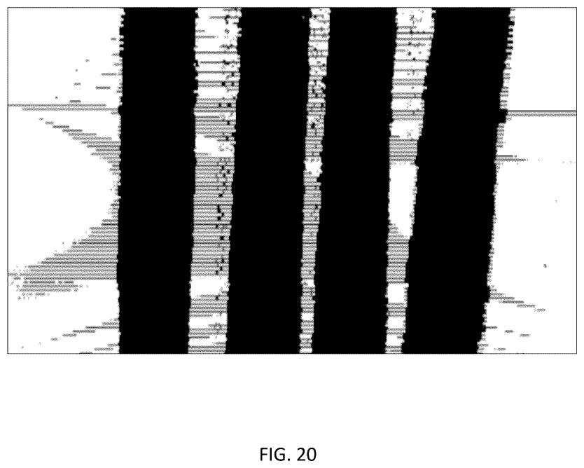

FIG. 18 illustrates a blockage energy map of large droplets of water applied to one small area of the window. FIG. 19 illustrates a detection mask with synthetic circular obscurants on the window. FIG. 20 illustrates a detection mask calculated for a human hand.

In particular embodiments, certain features described herein in the context of separate implementations may also be combined and implemented in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variations of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed. Moreover, the separation of various system components in the implementations described herein should not be understood as requiring such separation in all implementations, and it should be understood that the described program components and systems may be integrated together in a single software product or packaged into multiple software products.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layouts of the devices illustrated.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B or C” means at least one of the following: A; B; C; A and B; A and C; B and C; A, B and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by ±0.5%, ±1%, ±2%, ±3%, ±4%, ±5%, ±10%, ±12%, or ±15%. The term “substantially constant” refers to a value that varies by less than a particular amount over any suitable time interval. For example, a value that is substantially constant may vary by less than or equal to 20%, 10%, 1%, 0.5%, or 0.1% over a time interval of approximately 104 s, 103 s, 102 s, 10 s, 1 s, 100 ms, 10 ms, 1 ms, 100 μs, 10 μs, or 1 μs. The term “substantially constant” may be applied to any suitable value, such as for example, an optical power, a pulse repetition frequency, an electrical current, a wavelength, an optical or electrical frequency, or an optical or electrical phase.

As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

As used herein, the terms “based on” and “based at least in part on” may be used to describe or present one or more factors that affect a determination, and these terms may not exclude additional factors that may affect a determination. A determination may be based solely on those factors which are presented or may be based at least in part on those factors. The phrase “determine A based on B” indicates that B is a factor that affects the determination of A. In some instances, other factors may also contribute to the determination of A. In other instances, A may be determined based solely on B.

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
a light source configured to emit light;
a scanner configured to scan the emitted light through a window at a first range of azimuth angles and a first range of elevation angles;
a first detector positioned to receive at least a portion of the emitted light scattered by a target located downrange from the system;
a second detector positioned to receive at least a portion of the emitted light scattered by a window obscurant on the window;
a third detector positioned to receive at least a portion of the emitted light scattered by a close obscurant located within a distance range that is between a minimum detection distance associated with the first detector and a maximum detection distance associated with the second detector; and
a processor configured to determine whether an obscurant located closer to the window than the minimum detection distance associated with the first detector is detected based on one or more signal properties of the second detector and one or more signal properties of the third detector.

2. The system of claim 1, wherein the processor is configured to compare at least some of the one or more signal properties of the second detector and at least some of the one or more signal properties of the third detector to determine whether the detected obscurant is located on the window or in front of the window.

3. The system of claim 2, wherein the processor is configured to:
in response to determining that the detected obscurant is located on the window, initiate a cleaning process of the window.

4. The system of claim 2, wherein the processor is configured to:
in response to determining that the detected obscurant is located in front of the window, turn off or reduce a power of the light source for at least a predetermined period of time.

5. The system of claim 1, wherein the scanner is configured to:
scan the emitted light through the window to form a plurality of over-scanning rays to cover an over-scanning area at an additional second range of azimuth angles outside the first range of azimuth angles and an additional second range of elevation angles outside the first range of elevation angles.

6. The system of claim 5, wherein the over-scanning area comprises an area in a cumulated receive aperture that is not covered by a corresponding cumulated transmit aperture, wherein the cumulated transmit aperture comprises a geometric locus of intersections of a plurality of outgoing light rays with the window, and wherein the cumulated receive aperture comprises a geometric locus of a plurality of incoming returns from the target located downrange from the system.

7. The system of claim 5, wherein the processor is configured to:
stop monitoring of signal properties of the first detector corresponding to returns of the plurality of over-scanning rays from the target located downrange from the system.

8. The system of claim 1, wherein the one or more signal properties of the second detector comprise a range metric of the second detector and an energy metric of the second detector, and wherein the one or more signal properties of the third detector comprise a range metric of the third detector and an energy metric of the third detector.

9. The system of claim 8, wherein the processor is configured to:
in response to determining that the energy metric of the second detector is greater than the energy metric of the third detector, determine whether the energy metric of the second detector is equal to or above a predefined energy threshold for the second detector;
in response to determining that the energy metric of the second detector is equal to or above the predefined energy threshold for the second detector, determine that the detected obscurant is located on the window and determine a blockage severity level associated with the detected obscurant;
in response to determining that the energy metric of the second detector is below the predefined energy threshold for the second detector, determine whether the range metric of the second detector is below a predetermined range threshold for the second detector;
in response to determining that the range metric of the second detector is below the predetermined range threshold for the second detector, determine that the detected obscurant is located on the window and determine the blockage severity level associated with the detected obscurant; and
in response to determining that the range metric of the second detector is equal to or above the predetermined range threshold for the second detector, determine that no obscurant is detected.

10. The system of claim 8, wherein the processor is configured to:
in response to determining that the energy metric of the second detector is equal to or less than the energy metric of the third detector, determine whether the energy metric of the third detector is equal to or above a predefined energy threshold for the third detector;
in response to determining that the energy metric of the third detector is equal to or above the predefined energy threshold for the third detector, determine that the detected obscurant is located in front of the window and determine a blockage severity level associated with the detected obscurant;
in response to determining that the energy metric of the third detector is below the predefined energy threshold for the third detector, determine whether the range metric of the third detector is below a predetermined range threshold for the third detector;
in response to determining that the range metric of the third detector is below the predetermined range threshold for the third detector, determine that the detected obscurant is located in front of the window and determine the blockage severity level associated with the detected obscurant; and
in response to determining that the range metric of the third detector is equal to or above the predetermined range threshold for the third detector, determine that no obscurant is detected.

11. A method, comprising:
emitting light from a light source of a system;
scanning, by a scanner, the emitted light through a window at a first range of azimuth angles and a first range of elevation angles;
positioning a first detector to receive at least a portion of the emitted light scattered by a target located downrange from the system;
positioning a second detector to receive at least a portion of the emitted light scattered by a window obscurant on the window;
positioning a third detector to receive at least a portion of the emitted light scattered by a close obscurant located within a distance range that is between a minimum detection distance associated with the first detector and a maximum detection distance associated with the second detector; and
determining, using a processor, whether an obscurant located closer to the window than the minimum detection distance associated with the first detector is detected based on one or more signal properties of the second detector and one or more signal properties of the third detector.

12. The method of claim 11, further comprising:
comparing at least some of the one or more signal properties of the second detector and at least some of the one or more signal properties of the third detector to determine whether the detected obscurant is located on the window or in front of the window.

13. The method of claim 12, further comprising:
in response to determining that the detected obscurant is located on the window, initiating a cleaning process of the window.

14. The method of claim 11, further comprising:
scanning the emitted light through the window to form a plurality of over-scanning rays to cover an over-scanning area at an additional second range of azimuth angles outside the first range of azimuth angles and an additional second range of elevation angles outside the first range of elevation angles.

15. The method of claim 14, wherein the over-scanning area comprises an area in a cumulated receive aperture that is not covered by a corresponding cumulated transmit aperture, wherein the cumulated transmit aperture comprises a geometric locus of intersections of a plurality of outgoing light rays with the window, and wherein the cumulated receive aperture comprises a geometric locus of a plurality of incoming returns from the target located downrange from the system.

16. The method of claim 14, further comprising:
stopping monitoring signal properties of the first detector corresponding to returns of the plurality of over-scanning rays from the target located downrange from the system.

17. The method of claim 11, wherein the one or more signal properties of the second detector comprise a range metric of the second detector and an energy metric of the second detector, and wherein the one or more signal properties of the third detector comprise a range metric of the third detector and an energy metric of the third detector.

18. The method of claim 17, further comprising:
in response to determining that the energy metric of the second detector is greater than the energy metric of the third detector, determining whether the energy metric of the second detector is equal to or above a predefined energy threshold for the second detector;
in response to determining that the energy metric of the second detector is equal to or above the predefined energy threshold for the second detector, determining that the detected obscurant is located on the window and determining a blockage severity level associated with the detected obscurant;
in response to determining that the energy metric of the second detector is below the predefined energy threshold for the second detector, determining whether the range metric of the second detector is below a predetermined range threshold for the second detector;
in response to determining that the range metric of the second detector is below the predetermined range threshold for the second detector, determining that the detected obscurant is located on the window and determining the blockage severity level associated with the detected obscurant; and
in response to determining that the range metric of the second detector is equal to or above the predetermined range threshold for the second detector, determining that no obscurant is detected.

19. The method of claim 17, further comprising:
in response to determining that the energy metric of the second detector is equal to or less than the energy metric of the third detector, determining whether the energy metric of the third detector is equal to or above a predefined energy threshold for the third detector;
in response to determining that the energy metric of the third detector is equal to or above the predefined energy threshold for the third detector, determining that the detected obscurant is located in front of the window and determining a blockage severity level associated with the detected obscurant;
in response to determining that the energy metric of the third detector is below the predefined energy threshold for the third detector, determining whether the range metric of the third detector is below a predetermined range threshold for the third detector;
in response to determining that the range metric of the third detector is below the predetermined range threshold for the third detector, determining that the detected obscurant is located in front of the window and determining the blockage severity level associated with the detected obscurant; and
in response to determining that the range metric of the third detector is equal to or above the predetermined range threshold for the third detector, determining that no obscurant is detected.

20. A system, comprising:
a processor configured to:
determine one or more signal properties of a second detector and one or more signal properties of a third detector, wherein a first detector is positioned to receive at least a portion of emitted light scattered by a target located downrange from the system, and wherein the second detector is positioned to receive at least a portion of the emitted light scattered by a window obscurant on a window, and wherein the third detector is positioned to receive at least a portion of the emitted light scattered by a close obscurant located within a distance range that is between a minimum detection distance associated with the first detector and a maximum detection distance associated with the second detector, wherein the emitted light is emitted by a light source, and wherein the emitted light is scanned through the window at a first range of azimuth angles and a first range of elevation angles by a scanner; and
use the determined one or more signal properties of the second detector and the one or more signal properties of the third detector to determine whether an obscurant located closer to the window than the minimum detection distance associated with the first detector is detected; and
a memory coupled to the processor and configured to provide the processor with instructions.
